(19) United States
(12) Patent Application Publication
(10) Pub. No.: US 2026/0124755 A1
(43) Pub. Date: May 7, 2026

(54) POSITION ADJUSTMENT METHOD OF MANIPULATOR

(71) Applicant: OKUMA CORPORATION, Niwa-Gun (JP)

(72) Inventors: Tetsuya MATSUSHITA, Niwa-Gun (JP); Ryo NAKANISHI, Niwa-Gun (JP)

(73) Assignee: OKUMA CORPORATION, Niwa-Gun (JP)

(21) Appl. No.: 19/322,796

(22) Filed: Sep. 9, 2025

(30) Foreign Application Priority Data
Sep. 20, 2024 (JP) 2024-164168

(51) Int. Cl. B25J 9/16; B25J 11/00; B25J 13/08

(52) U.S. Cl. CPC B25J 9/1692; B25J 11/005; B25J 13/089

(57) ABSTRACT

A position adjustment method of a manipulator in a machining system includes: positioning the manipulator such that a reference object having a specific shape gripped by or secured to an end effector is positioned at a workpiece grasping preparation position; mounting a contact-type sensor on a tool rest, moving the tool rest such that the contact-type sensor is brought into contact with the reference object, obtaining positions of translational drive axes at time points, and calculating contact point positions from the obtained translational drive axis positions; calculating an error of a position and/or a posture of the reference object gripped by or secured to the end effector from a plurality of the contact point positions and a command value; and compensating the position and/or the posture of the end effector so as to cancel the error of the position and/or the posture of the reference object.

### CROSS REFERENCE TO RELATED APPLICATION

This application claims the benefit of Japanese Patent Application Number 2024-164168 filed on Sep. 20, 2024, the entirety of which is incorporated by reference.

### FIELD OF THE INVENTION

The disclosure relates to a position adjustment method of a manipulator for adjusting a carry-in position when a workpiece is carried into and out of a machine tool by a manipulator using an industrial robot.

### BACKGROUND OF THE INVENTION

In an automated manufacturing system constituted of a facility, such as an industrial robot and a machine tool including a manipulator, the industrial robot uses the manipulator to automatically perform a sequence of operations. The sequence of operations is of picking up a material of a workpiece from a workpiece stocker that is a storage area of the workpiece and carrying the material into the machine tool, and, after the machine tool machines the workpiece, carrying the machined workpiece out and returning the workpiece to the workpiece stocker.

The operation by the manipulator of the industrial robot is instructed by a teaching work of a position and posture of an end effector at each position on a motion trajectory. The teaching work is performed by positioning the manipulator at a desired position using an operation pendant, and recording a current position of each axis of the manipulator then.

In position teaching in which a workpiece is carried into a machine tool and a grasping portion of the machine tool is caused to grasp the workpiece, when it is necessary to keep the grasping position in a predetermined tolerance, for example, at the grasping position and a preparation position in its vicinity, the position and posture of the workpiece are finely adjusted. One method for executing the fine adjustment is a fine adjustment of a position and posture of the manipulator. However, the fine adjustment is often executed with a visual observation, which is an operation that requires significant time and effort. In addition, a relative position between the machine tool and the industrial robot slightly changes due to secular change of a surrounding environment, such as a floor base, which shifts a carry-in position. Accordingly, re-teaching is periodically required, and time and effort are required each time.

Therefore, in order to efficiently execute teaching, a unit to measure a position and posture between the workpiece and the machine tool is important.

JP 2022-522131 A discloses a method that enables a measurement of a position and posture of a workpiece by measuring a workpiece gripped by a manipulator using two sensor units disposed in a peripheral area of a chuck that grasps the workpiece in a machine tool, and measuring the workpiece by rotating the sensor units about the chuck, and adjusts the position and posture of the workpiece based on a measurement result.

JP 6785931 B discloses a method that preliminarily records a reference image by photographing a marker disposed in a machine tool using a camera attached on a robot while a manipulator is in the machine tool, photographs the marker again when the manipulator enters the machine tool again, and estimates an attitude error amount of the manipulator from a difference between the photographed image and the reference image.

The method in JP 2022-522131 A has an issue that a special sensor unit disposed in the peripheral area of the chuck is necessary. Removal/mounting of the sensor unit is necessary before and after teaching, which basically requires a human intervention, and therefore, there also is an issue that an automatic measurement is not possible.

On the other hand, the method in JP 6785931 B has an issue that a relatively expensive camera is necessary. Furthermore, photographing the marker using the camera does not allow a position measurement with high accuracy, which is not applicable when a position tolerance necessary for grasping the workpiece in the machine tool is small. There also is an issue that a workpiece grasping position fails to be precisely measured because a marker photographing position and the workpiece grasping position are different.

Therefore, it is an object of the disclosure to provide a position adjustment method of a manipulator that measures a position and posture of a workpiece near a carry-in position when the workpiece gripped by the manipulator of an industrial robot is carried into a machine tool using a contact-type sensor mounted on a tool main spindle of the machine tool, and adjusts a position and posture of an end effector of the manipulator based on a measurement result.

### SUMMARY OF THE INVENTION

In order to solve the above-described issues, a first configuration of the present disclosure is a position adjustment method of a manipulator in a machining system. The machining system includes: a machine tool including a chuck configured to grasp a workpiece, a tool rest on which a tool is mountable, and three or more translational drive axes that enable a translational motion of the tool rest; and a manipulator having an end effector configured to grip the workpiece and a plurality of joint driving axes. The position adjustment method of the manipulator adjusts a position and/or a posture of the end effector at a workpiece grasping position at which the workpiece gripped by the end effector is grasped by the chuck. The position adjustment method includes: a first reference object positioning step of positioning the manipulator such that a reference object having a specific shape gripped by or secured to the end effector is positioned at a workpiece grasping preparation position near the workpiece grasping position; a first reference object position measuring step of (i) mounting a contact-type sensor on the tool rest, (ii) moving the tool rest such that the contact-type sensor is brought into contact with the reference object positioned at the first reference object positioning step, (iii) obtaining positions of the translational drive axes when the contact-type sensor detects contacts, and (iv) calculating contact point positions from the obtained translational drive axis positions; a first reference object position error calculating step of calculating an error of a position and/or a posture of the reference object gripped by or secured to the end effector from a plurality of the contact point positions obtained by executing the first reference object position measuring step for a plurality of positions of the reference object and a command value of the position and posture of the end effector at the first reference object positioning step; a first manipulator position compensating step of compensating the position and/or the posture of the end effector so as to cancel the error of the position and/or the posture of the reference object calculated at the first reference object position error calculating step.

Another aspect of the first configuration, which is in the above-described configuration, further includes: a second reference object positioning step of positioning the manipulator such that the reference object gripped by or secured to the end effector has a position and/or a posture different from that at the first reference object positioning step; a second reference object position measuring step of (i) moving the tool rest such that the contact-type sensor mounted on the tool rest is brought into contact with the reference object gripped by or secured to the end effector positioned at the second reference object positioning step, (ii) obtaining positions of the translational drive axes when the contact-type sensor detects contacts, and (iii) calculating contact point positions from the obtained positions of the translational drive axes; and a first reference object dimension measuring step of calculating dimensions of the reference object from a plurality of the contact point positions obtained by executing the second reference object position measuring step for a plurality of positions of the reference object. In the first reference object position error calculating step, the error of the position and/or the posture of the reference object gripped by or secured to the end effector is calculated further using the reference object dimensions calculated at the first reference object dimension measuring step.

In another aspect of the present disclosure, which is in the above-described configuration, when the error of the position and/or the posture of the reference object calculated at the first reference object position error calculating step is equal to or more than a predetermined threshold, the first reference object positioning step to the first manipulator position compensating step are repeated.

In order to solve the above-described issues, a second configuration of the present disclosure is a position adjustment method of a manipulator in a machining system. The machining system includes: a machine tool including a chuck configured to grasp a workpiece, a tool rest on which a tool is mountable, and three or more translational drive axes that enable a translational motion of the tool rest; and a manipulator having an end effector configured to grip the workpiece and a plurality of joint driving axes. The position adjustment method of the manipulator adjusts a position and/or a posture of the end effector at a workpiece grasping position at which the workpiece gripped by the end effector is grasped by the chuck. The position adjustment method includes: a first confirmation positioning step of positioning the manipulator such that a reference object having a specific shape gripped by or secured to the end effector is positioned at a preset workpiece confirmation position; a first confirmation measurement step of (i) mounting a contact-type sensor on the tool rest, (ii) moving the tool rest such that the contact-type sensor is brought into contact with the reference object positioned at the first confirmation positioning step, (iii) obtaining positions of the translational drive axes when the contact-type sensor detects contacts, and (iv) calculating contact point positions from the obtained positions of the translational drive axes; a first confirmation position calculating step of calculating a position and/or a posture of the reference object gripped by or secured to the end effector from a plurality of the contact point positions obtained by executing the first confirmation measurement step for a plurality of positions of the reference object; a first position change amount calculating step of calculating an amount of change of the position and/or the posture of the reference object from a calculated value of the position and/or the posture of the reference object calculated at the first confirmation position calculating step and a recorded value of the position and/or the posture of the reference object measured in advance and recorded; and a first confirmation position compensating step of compensating the position and/or the posture of the end effector so as to cancel the amount of change calculated at the first position change amount calculating step.

Another aspect of the second configuration, which is in the above-described configuration, further includes: a second confirmation positioning step of positioning the manipulator such that the reference object gripped by or secured to the end effector has a position and/or a posture different from that at the first confirmation positioning step; a second confirmation position measuring step of (i) moving the tool rest such that the contact-type sensor mounted on the tool rest is brought into contact with the reference object gripped by or secured to the end effector positioned at the second confirmation positioning step, (ii) obtaining positions of the translational drive axes when the contact-type sensor detects contacts, and (iii) calculating contact point positions from the obtained positions of the translational drive axes; and a second reference object dimension measuring step of calculating dimensions of the reference object from a plurality of the contact point positions obtained by executing the second confirmation position measuring step for a plurality of positions of the reference object. In the first confirmation position calculating step, the position and/or the posture of the reference object gripped by or secured to the end effector is calculated further using the reference object dimensions measured at the second reference object dimension measuring step.

In another aspect of the second configuration, which is in the above-described configuration, when the amount of change calculated at the first position change amount calculating step is equal to or more than a predetermined threshold, the first confirmation positioning step to the first confirmation position compensating step are repeated.

In order to solve the above-described issues, a third configuration of the present disclosure is a position adjustment method of a manipulator in a machining system. The machining system includes: a machine tool including a chuck configured to grasp a workpiece, a tool rest on which a tool is mountable, and a translational drive axis for enabling the tool rest to perform a translational motion, the tool rest having two or less degree of freedom of the translational motion; and a manipulator having an end effector configured to grip the workpiece and a plurality of joint driving axes. The position adjustment method of the manipulator adjusts a position and/or a posture of the end effector at a workpiece grasping position at which the workpiece gripped by the end effector is grasped by the chuck. The position adjustment method includes: a third reference object positioning step of positioning the manipulator such that the reference object having a specific shape gripped by or secured to the end effector is positioned at a workpiece grasping preparation position near the workpiece grasping position; a first machine tool position measuring step of (i) moving the tool rest such that a contact-type sensor mounted on the tool rest is brought into contact with the reference object positioned at the third reference object positioning step, (ii) obtaining a position of the translational drive axis when the contact-type sensor detects a contact, and (iii) calculating a machine tool contact point position from the obtained position of the translational drive axis; a first sensor positioning step of positioning the tool rest such that the contact-type sensor mounted on the tool rest is positioned at the workpiece grasping preparation position; a first manipulator position measuring step of (i) moving the end effector such that the reference object gripped by or secured to the end effector is brought into contact with the contact-type sensor positioned at the first sensor positioning step, (ii) obtaining positions of the joint driving axes when the contact-type sensor detects contacts, and (iii) calculating manipulator contact point positions from the obtained positions of the joint driving axes; a second reference object position error calculating step of calculating an error of a position and/or a posture of the reference object gripped by or secured to the end effector at the workpiece grasping preparation position from a command value of the position and posture of the end effector at the third reference object positioning step, a plurality of the machine tool contact point positions obtained by executing the first machine tool position measuring step for a plurality of positions of the reference object, a command value of a plurality of positions of the tool rest when the first sensor positioning step is executed at a plurality of positions of the workpiece grasping preparation position, and a plurality of the manipulator contact point positions obtained by executing the first manipulator position measuring step at the plurality of positions of the workpiece grasping preparation positions; and a second manipulator position compensating step of compensating the position and/or the posture of the end effector so as to cancel the error of the position and/or the posture of the reference object calculated at the second reference object position error calculating step.

Another aspect of the third configuration, which is in the above-described configuration, further includes: a fourth reference object positioning step of positioning the manipulator such that the reference object gripped by or secured to the end effector has a position and/or a posture different from that at the third reference object positioning step; a second machine tool position measuring step of (i) moving the tool rest such that the contact-type sensor mounted on the tool rest is brought into contact with the reference object positioned at the fourth reference object positioning step, (ii) obtaining a position of the translational drive axis when the contact-type sensor detects a contact, and (iii) calculating machine tool contact point positions from the obtained position of the translational drive axis; and a third reference object dimension measuring step of calculating dimensions of the reference object from a plurality of the machine tool contact point positions obtained by executing the second machine tool position measuring step for a plurality of positions of the reference object. In the second reference object position error calculating step, the error of the position and/or the posture of the reference object gripped by or secured to the end effector is calculated further using the reference object dimensions obtained at the third reference object dimension measuring step.

In another aspect of the third configuration, which is in the above-described configuration, when the error of the position and/or the posture of the reference object calculated at the second reference object position error calculating step is equal to or more than a predetermined threshold, the third reference object positioning step to the second manipulator position compensating step are repeated.

In order to solve the above-described issues, a fourth configuration of the present disclosure is a position adjustment method of a manipulator in a machining system. The machining system includes: a machine tool including a chuck configured to grasp a workpiece, a tool rest on which a tool is mountable, and a translational drive axis for enabling the tool rest to perform a translational motion, the tool rest having two or less degree of freedom of the translational motion; and a manipulator having an end effector configured to grip the workpiece and a plurality of joint driving axes. The position adjustment method of the manipulator adjusts a position and/or a posture of the end effector at a workpiece grasping position at which the workpiece gripped by the end effector is grasped by the chuck. The position adjustment method includes: a third confirmation positioning step of positioning the manipulator such that the reference object having a specific shape gripped by or secured to the end effector is positioned at a workpiece confirmation position different from the workpiece grasping position; a third machine tool position measuring step of (i) moving the tool rest such that a contact-type sensor mounted on the tool rest is brought into contact with the reference object positioned at the third confirmation positioning step, (ii) obtaining a position of the translational drive axis when the contact-type sensor detects a contact, and (iii) calculating a machine tool contact point position from the obtained position of the translational drive axis; a second sensor positioning step of positioning the tool rest such that the contact-type sensor mounted on the tool rest is positioned at the workpiece confirmation position; a second manipulator position measuring step of (i) moving the end effector such that the reference object gripped by or secured to the end effector is brought into contact with the contact-type sensor positioned at the second sensor positioning step, (ii) obtaining positions of the joint driving axes when the contact-type sensor detects contacts, and (iii) calculating manipulator contact point positions from the obtained positions of the joint driving axes; a second confirmation position calculating step of calculating a position and/or a posture of the reference object gripped by or secured to the end effector at the workpiece confirmation position from a command value of the position and posture of the end effector at the third confirmation positioning step, a plurality of the machine tool contact point positions obtained by executing the third machine tool position measuring step for a plurality of positions of the reference object, a command value of a plurality of positions of the tool rest when the second sensor positioning step is executed at a plurality of positions of the workpiece confirmation position, and a plurality of the manipulator contact point positions obtained by executing the second manipulator position measuring step at a plurality of positions of the workpiece confirmation positions; a second position change amount calculating step of calculating an amount of change in the position and/or the posture of the reference object from a calculated value of the position and/or the posture of the reference object calculated at the second confirmation position calculating step and a recorded value of the position and/or the posture of the reference object measured in advance and recorded; and a second confirmation position compensating step of compensating the position and/or the posture of the end effector so as to cancel the amount of change calculated at the second position change amount calculating step.

In another aspect of the fourth configuration, which is in the above-described configuration, when the amount of change in the position and/or the posture of the reference object calculated at the second position change amount calculating step is equal to or more than a predetermined threshold, the third confirmation positioning step to the second confirmation position compensating step are repeated.

In order to solve the above-described issues, a fifth configuration of the present disclosure, which is in the above-described configuration, is a position adjustment method of a manipulator in a machining system. The machining system includes: a machine tool including a chuck configured to grasp a workpiece, a tool rest on which a tool is mountable, and a translational drive axis for enabling the tool rest to perform a translational motion; and a manipulator having an end effector configured to grip the workpiece and a plurality of joint driving axes. The position adjustment method of the manipulator adjusts a position and/or a posture of the end effector at a workpiece grasping position at which the workpiece gripped by the end effector is grasped by the chuck. The position adjustment method includes: a third sensor positioning step of positioning the tool rest such that a contact-type sensor mounted on the tool rest is positioned at a workpiece grasping preparation position near the workpiece grasping position; a third manipulator position measuring step of (i) moving the end effector such that the reference object gripped by or secured to the end effector is brought into contact with the contact-type sensor positioned at the third sensor positioning step, (ii) obtaining a position of the joint driving axis when the contact-type sensor detects a contact, and (iii) calculating a contact point position from the obtained position of the joint driving axis a third reference object position error calculating step of calculating an error of a position and/or a posture of the reference object gripped by or secured to the end effector at the workpiece grasping preparation position from command values of a plurality of positions of the tool rest when the third sensor positioning step is executed for a plurality of positions of the workpiece grasping preparation position and a plurality of the contact point positions obtained by executing the third manipulator position measuring step at a plurality of positions of the workpiece grasping preparation position; a third manipulator position compensating step of compensating the position and/or the posture of the end effector so as to cancel the error of the position and/or the posture of the reference object calculated at the third reference object position error calculating step.

Another aspect of the fifth configuration, which is in the above-described configuration, further includes: a fourth sensor positioning step of positioning the tool rest such that the contact-type sensor mounted on the tool rest is positioned at a dimension measurement position different from the workpiece grasping preparation position; a fourth manipulator position measuring step of (i) moving the end effector such that the reference object gripped by or secured to the end effector is brought into contact with the contact-type sensor positioned at the fourth sensor positioning step, (ii) obtaining a position of the joint driving axis when the contact-type sensor detects a contact, and (iii) calculating a contact point position from the obtained position of the joint driving axis; and a fifth reference object dimension measuring step of calculating dimensions of the reference object from a plurality of the contact point positions obtained by executing the fourth manipulator position measuring step for a plurality of positions of the reference object. In the third reference object position error calculating step, the error of the position and/or the posture of the reference object gripped by or secured to the end effector is calculated further using the reference object dimensions obtained at the fifth reference object dimension measuring step.

In another aspect of the fifth configuration, which is in the above-described configuration, when the error of the position and/or the posture of the reference object calculated at the third reference object position error calculating step is equal to or more than a predetermined threshold, the third sensor positioning step to the third manipulator position compensating step are repeated.

In another aspect of the fifth configuration, which is in the above-described configuration, the tool rest has two or less degree of freedom of the translational motion.

In order to solve the above-described issues, a sixth configuration of the present disclosure is a position adjustment method of a manipulator in a machining system. The machining system includes: a machine tool including a chuck configured to grasp a workpiece, a tool rest on which a tool is mountable, and a translational drive axis for enabling the tool rest to perform a translational motion; and a manipulator having an end effector configured to grip the workpiece and a plurality of joint driving axes. The position adjustment method of the manipulator adjusts a position and/or a posture of the end effector at a workpiece grasping position at which the workpiece gripped by the end effector is grasped by the chuck. The position adjustment method includes: a fifth sensor positioning step of positioning the tool rest such that a contact-type sensor mounted on the tool rest is positioned at a workpiece confirmation position different from the workpiece grasping position; a fifth manipulator position measuring step of (i) moving the end effector such that the reference object gripped by or secured to the end effector is brought into contact with the contact-type sensor positioned at the fifth sensor positioning step, (ii) obtaining a position of the joint driving axis when the contact-type sensor detects a contact, and (iii) calculating a contact point position from the obtained position of the joint driving axis; a third confirmation position calculating step of calculating a position and/or a posture of the reference object gripped by the end effector from command values of a plurality of positions of the tool rest when the fifth sensor positioning step is executed for a plurality of positions of the workpiece confirmation position and a plurality of the contact point positions obtained by executing the fifth manipulator position measuring step at a plurality of positions of the workpiece confirmation position; a third position change amount calculating step of calculating an amount of change in the position and/or the posture of the reference object from a calculated value of the position and/or the posture of the reference object calculated at the third confirmation position calculating step and a recorded value of the position and/or the posture of the reference object measured in advance and recorded; and a third confirmation position compensating step of compensating the position and/or the posture of the end effector so as to cancel the amount of change calculated at the third position change amount calculating step.

In another aspect of the sixth configuration, which is in the above-described configuration, when the amount of change in the position and/or the posture of the reference object calculated at the third position change amount calculating step is equal to or more than a predetermined threshold, the fifth sensor positioning step to the third confirmation position compensating step are repeated.

In another aspect of the sixth configuration, which is in the above-described configuration, the tool rest has two or less degree of freedom of the translational motion.

The disclosure measures a position and/or a posture of a reference object carried in by a manipulator using a contact-type sensor, and adjusts a position and/or a posture of the manipulator based on a measurement result. Accordingly, a special device, such as a special sensor unit and camera, is not used. Therefore, for example, a touch trigger probe, which is an accessory of a machine tool and is a relatively low-priced contact-type sensor, is used to execute a position adjustment of the manipulator.

Furthermore, the position and posture of the reference object is calculated using a position of the contact-type sensor positioned with high positioning accuracy of the machine tool as a reference, and thus, a position and posture of the workpiece is adjustable with high accuracy.

The measurement using the contact-type sensor is automatically performable, thereby allowing for an automatic adjustment of the position of the workpiece.

### BRIEF DESCRIPTION OF THE DRAWINGS

FIG. 1 is a schematic diagram of a machine tool relating to the disclosure.

FIG. 2 is a schematic diagram of a machining cell relating to the disclosure.

FIG. 3 is a schematic diagram of a positional relationship of a reference workpiece at a workpiece grasping preparation position.

FIG. 4 is a flowchart relating to a method of a first disclosure.

FIG. 5 is a schematic diagram of an error of a position and posture of the reference workpiece at the workpiece grasping preparation position.

FIG. 6 is a schematic diagram of measurements of a columnar-shaped reference workpiece at the workpiece grasping preparation position.

FIG. 7 is a schematic diagram of measurements of a prism-shaped reference workpiece at the workpiece grasping preparation position.

FIG. 8 is a flowchart relating to a method of a second disclosure.

FIG. 9 is a schematic diagram of a positional relationship of the reference workpiece at a dimension measurement position.

FIG. 10 is a schematic diagram of measurements of the columnar-shaped reference workpiece at the dimension measurement position.

FIG. 11 is a schematic diagram of measurement positions of a regular-quadrangular-prism-shaped reference workpiece at the dimension measurement position.

FIG. 12 is a flowchart relating to a method of a third disclosure.

FIG. 13 is a schematic diagram of a positional relationship of the reference workpiece at a confirmation measurement position.

FIG. 14 is a flowchart relating to a method of a fourth disclosure.

FIG. 15 is a schematic diagram of a two-axis lateral lathe relating to the disclosure.

FIG. 16 is a schematic diagram of a machining cell relating to the disclosure.

FIG. 17 is a flowchart relating to a method of a fifth disclosure.

FIG. 18 is a schematic diagram of a positional relationship of the workpiece grasping preparation position.

FIG. 19 is a schematic diagram of measurements of the columnar-shaped reference workpiece at the workpiece grasping preparation position.

FIG. 20 is a schematic diagram of the measurements of the columnar-shaped reference workpiece at the workpiece grasping preparation position.

FIG. 21 is a schematic diagram of the measurements of the columnar-shaped reference workpiece at the workpiece grasping preparation position.

FIG. 22 is a schematic diagram of measurement positions of the prism-shaped reference workpiece at the workpiece grasping preparation position.

FIG. 23 is a flowchart relating to a method of a sixth disclosure.

FIG. 24 is a schematic diagram of a positional relationship of the dimension measurement position.

FIG. 25 is a schematic diagram of measurements of the reference workpiece at the dimension measurement position.

FIG. 26 is a flowchart relating to a method of a seventh disclosure.

FIG. 27 is a schematic diagram of a positional relationship of a workpiece confirmation position.

FIG. 28 is a flowchart relating to a method of an eighth disclosure.

FIG. 29 is a schematic diagram of measurement positions of the columnar-shaped reference workpiece at the workpiece grasping preparation position.

FIG. 30 is a schematic diagram of measurement positions of the columnar-shaped reference workpiece at the workpiece grasping preparation position.

FIG. 31 is a schematic diagram of measurements of the reference workpiece at the dimension measurement position.

FIG. 32 is a flowchart relating to a method of a ninth disclosure.

FIG. 33 is a flowchart relating to a method of a tenth disclosure.

### DETAILED DESCRIPTION OF THE INVENTION

The following describes embodiments embodying the disclosure in detail with reference to the drawings.

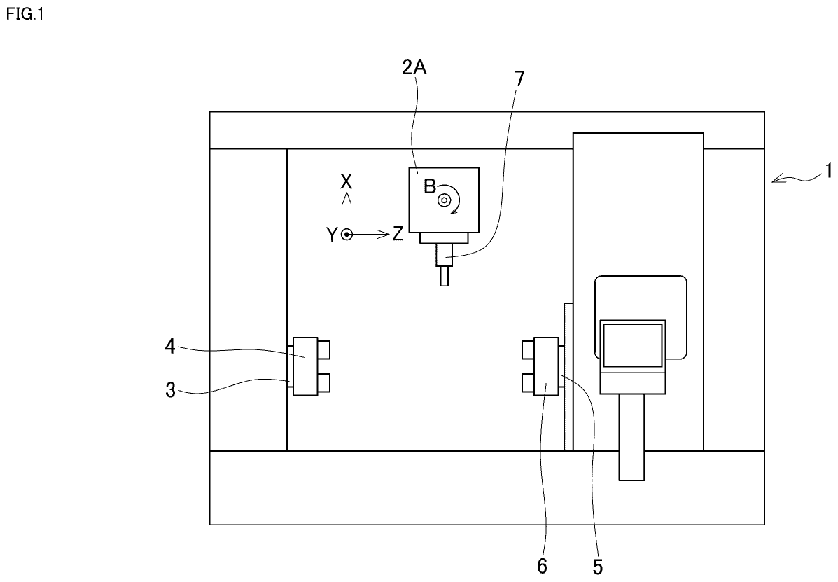

FIG. 1 is an explanatory view of a position adjustment method of a manipulator according to the disclosure, and illustrates an exemplary machine tool.

In a machine tool 1, a tool rest 2A includes a rotatable tool main spindle, and a tool 7, such as an end mill as a rotating tool or a single point tool as a non-rotating tool, is mountable on the tool rest 2A. The tool rest 2A is configured to perform a rotational motion of one degree of freedom at a B-axis. The tool rest 2A is configured to perform a translational motion of three degrees of freedom at an X-axis, Y-axis, and Z-axis, which are mutually orthogonal.

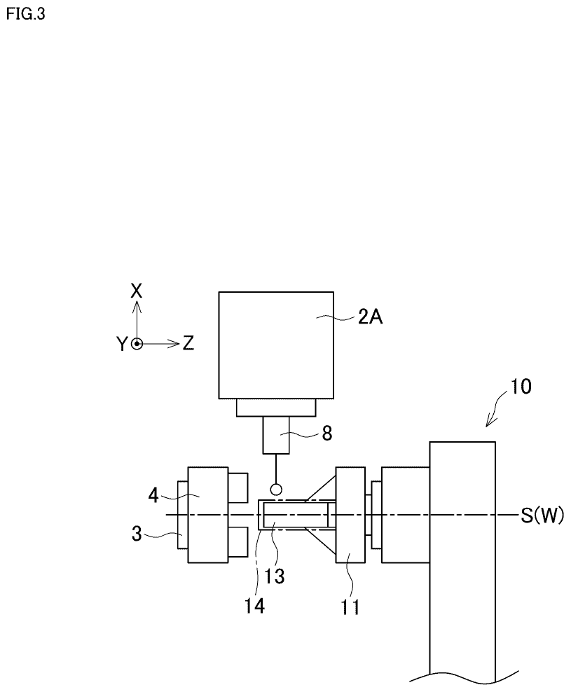

A chuck 4 has a plurality of openable/closable jaws, and is configured to grasp a workpiece. The chuck 4 is rotatable by a turning main spindle 3. A chuck 6 disposed to face the chuck 4 has a plurality of openable/closable jaws, and is rotatable by a second turning main spindle 5. The chuck 6 is configured to perform a translational motion of one degree of freedom by a W-axis (illustrated in FIG. 3). A driving mechanism, such as a feed axis and a motor relating to operations of respective portions in the machine tool 1, are controlled by a numerical control device NC1, which is not illustrated in the drawings. The numerical control device NC1 includes a CPU and a memory coupled to the CPU, and achieves various kinds of processes by using them.

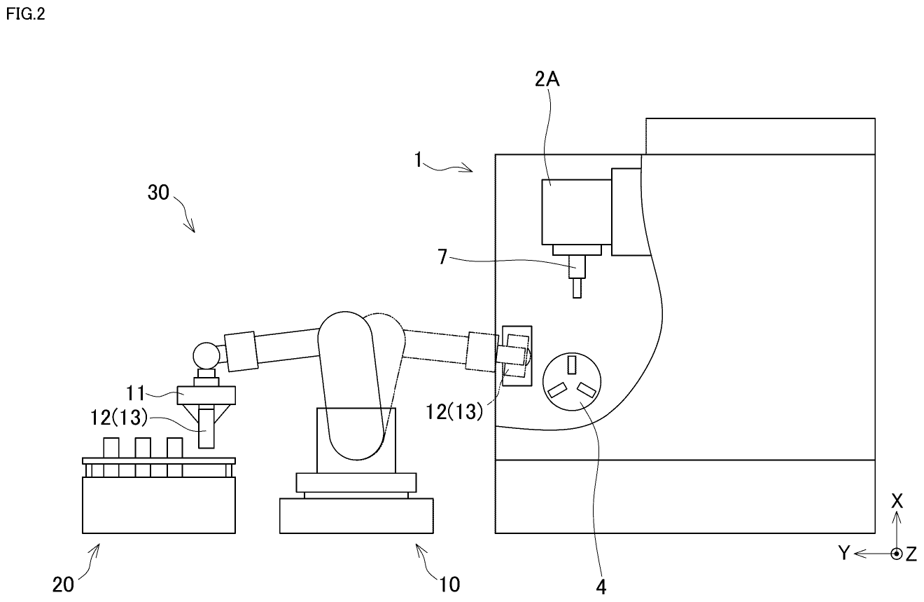

FIG. 2 is a schematic diagram illustrating an exemplary machining cell. A machining cell 30 as a machining system in the disclosure includes the machine tool 1, a manipulator 10, and a workpiece stocker 20 as illustrated in FIG. 2. The workpiece stocker 20 is able to store a plurality of workpieces 12. The manipulator 10 includes six joints and actuators. Therefore, the manipulator 10 is configured to perform a motion of six degrees of freedom of a position and posture of an end effector 11 mounted at a distal end. The end effector 11 includes an openable/closable hand and is able to grip the workpiece 12. The driving mechanism relating to the operations of the respective portions in the manipulator 10 is controlled by a numerical control device NC2, which is not illustrated in the drawings. The numerical control device NC2 includes a CPU and a memory coupled to the CPU, and achieves various kinds of processes by using them.

The manipulator 10 grips and takes out the workpiece 12 stored in the workpiece stocker 20 with the hand of the end effector 11. Subsequently, the manipulator 10 carries the workpiece 12 into the machine tool 1, and positions the workpiece 12 at a workpiece grasping position where the chuck 4 grasps the workpiece 12. The manipulator 10 opens the hand of the end effector 11 and retreats outside the machine tool 1 while the chuck 4 grasps the workpiece 12.

Thereafter, the machine tool 1 machines the workpiece 12. When the machining of the workpiece 12 by the machine tool 1 is terminated, the manipulator 10 takes out the workpiece 12 grasped by the chuck 4, and returns the workpiece 12 to the workpiece stocker 20. The machining cell 30 performs the sequence of operations for the plurality of workpieces 12, and thus, is able to automatically machine all the workpieces 12.

The machining operation of the machine tool 1 is performed in accordance with a program created in advance. Meanwhile, the operation of the manipulator 10 is performed in accordance with teaching data obtained by performing teaching in advance that records angles of the respective joints of the manipulator 10 positioned at a desired position and posture. Examples of a teaching position include, for example, respective grasping positions and approaching positions of the workpieces 12 in the workpiece stocker 20, intermediate passing points, a workpiece carry-in position inside the machine tool 1, a workpiece grasping position where the chuck 4 grasps the workpiece 12 and an approaching position.

The manipulator 10 does not have high absolute positioning accuracy, which is generally 0.1 mm or more. Therefore, when a fit tolerance of the chuck 4 is in 0.01 mm order, it is necessary to adjust the workpiece grasping position and the approaching position to the workpiece grasping position with high accuracy.

FIG. 3 is a schematic diagram of a positional relationship of a reference workpiece at a workpiece grasping preparation position 14, which will be described later.

In the embodiment, a touch trigger probe 8 as illustrated in FIG. 3 is used to adjust the position of the manipulator 10. The touch trigger probe 8 is a contact-type sensor. The touch trigger probe 8 has a sphere-shaped stylus at a tip, and outputs a signal when detecting that the stylus has touched a measurement target object.

In general, when the touch trigger probe 8 is used in the machine tool 1, the touch trigger probe 8 is mounted on the tool rest 2A and used. In the case, the tool rest 2A is moved such that the touch trigger probe 8 is brought into contact with the measurement target object, and an output signal when the touch trigger probe 8 and the measurement target object are brought into contact is received by the numerical control device NC1 of the machine tool 1. Subsequently, the numerical control device NC1 obtains respective positions of translational drive axes when the signal is received or when delay is taken into account. The numerical control device NC1 performs computations by considering a preset compensation value based on the obtained respective positions of the translational drive axes, and measures contact point positions of the translational drive axes in an axial direction. Thus, the positions of the contact points are measured by the move of the tool rest 2A, and therefore, the motion accuracy of the machine tool 1 is the measurement accuracy. When three axes or more translational drive axes are present, a three-dimensional position is measurable by contacts from three directions.

Meanwhile, the touch trigger probe 8 is mounted on the manipulator 10 and used in some cases. In the cases, the touch trigger probe 8 is attached to the end effector 11. The end effector 11 is moved such that the touch trigger probe 8 is brought into contact with the measurement target object, and an output signal when the touch trigger probe 8 and the measurement target object are brought into contact is received by the numerical control device NC2 of the manipulator 10. Subsequently, the numerical control device NC2 obtains respective positions of joint driving axes when the signal is received or when delay is taken into account. The numerical control device NC2 performs computations by considering a forward kinematics calculation, a deformation error due to the gravity, and a preset compensation value based on the obtained positions of the joint driving axes, and obtains a position and posture of the manipulator 10 at the contact points.

However, as described above, the motion accuracy of the manipulator 10 is low compared with that of the machine tool 1. Therefore, compared with the case where the touch trigger probe 8 is used in the machine tool 1, the measurement accuracy is low when the touch trigger probe 8 is used in the manipulator 10.

Therefore, in the disclosure, the touch trigger probes 8 mounted on the tool rest 2A and a tool rest 2B of the machine tool 1 are shared and used by the machine tool 1 and the manipulator 10. Specifically, both the numerical control device NC1 of the machine tool 1 and the numerical control device NC2 of the manipulator 10 are allowed to receive the output signal emitted by the one touch trigger probe 8. Accordingly, it may be possible to conveniently select which of the numerical control device NC1 and the numerical control device NC2 is used to compute the contact positions.

The following describes a position adjustment method of the manipulator 10 with respect to the machine tool 1 constituted as described above.

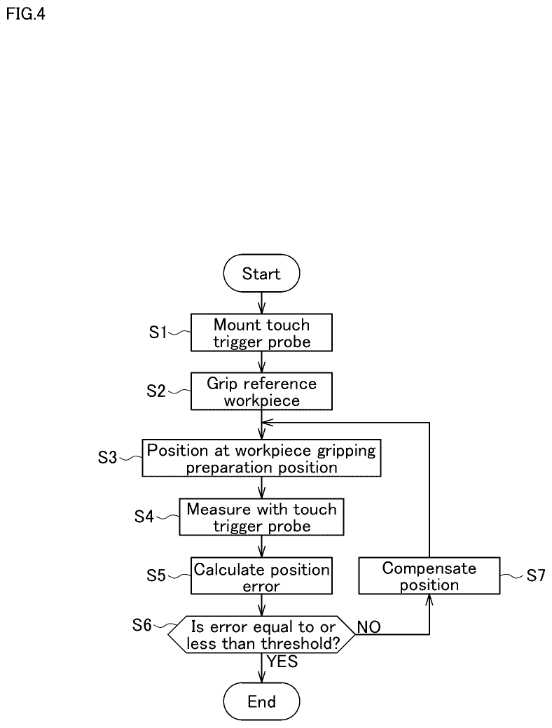

A first position adjustment method of the manipulator is described using the flowchart in FIG. 4. At Step S1, the touch trigger probe 8 is mounted on the tool rest 2A. At Step S2, the end effector 11 of the manipulator 10 is caused to grip a reference workpiece 13. Here, the reference workpiece 13 may be secured to the end effector 11. The end effector 11 having a portion corresponding to the reference workpiece 13 may be used.

It should be noted that the reference workpiece 13 is a reference object for measurement having a specific shape. The reference workpiece 13 has, for example, a quadrangular prism shape or a columnar shape as described later.

At Step S3, the manipulator 10 is positioned such that the reference workpiece 13 gripped by the end effector 11 is positioned at the workpiece grasping preparation position 14 in the machine tool 1 as in FIG. 3 (a first reference object positioning step).

It should be noted that the workpiece grasping preparation position 14 is a preparation position to a workpiece grasping position at which the workpiece 12 gripped by the end effector 11 of the manipulator 10 is gripped by the chuck 4. The preparation position is also referred to as an approaching position. The workpiece grasping preparation position 14 is, for example, a position close to the workpiece grasping position on a rotation axis S of the turning main spindle 3.

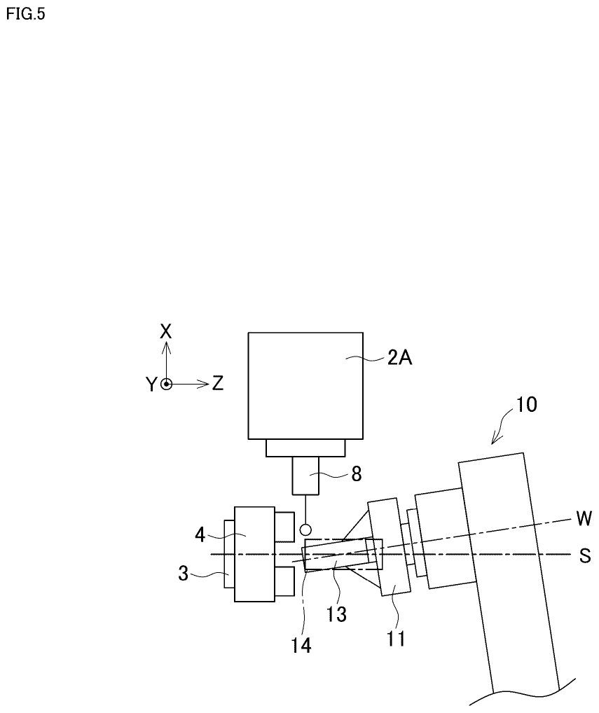

As illustrated in FIG. 3, when the reference workpiece 13 has a columnar shape, a center axis W of the reference workpiece 13 at the workpiece grasping preparation position 14 is parallel to the rotation axis S of the turning main spindle 3. X, Y coordinate values at the center of the reference workpiece 13 are in the state of corresponding to X, Y coordinate values of the rotational center of the turning main spindle 3, that is, a grasping center of the chuck 4. However, when the adjustment of the positional relationship between the manipulator 10 and the machine tool 1 is not sufficient, the center axis W of the reference workpiece 13 is in a state of inclined or shifted with respect to the rotation axis S of the turning main spindle 3 as illustrated in FIG. 5 when the positional relationship has been changed due to secular change. FIG. 5 illustrates a schematic diagram of an error of the position and posture of the reference workpiece 13 at the workpiece grasping preparation position 14.

At Step S4, a plurality of positions of the reference workpiece 13 positioned at the workpiece grasping preparation position 14 are measured. Specifically, the touch trigger probe 8 is brought into contact with the plurality of positions of the reference workpiece 13, and the contact point positions are measured from translational driving positions of the tool rest 2A (a first reference object position measuring step).

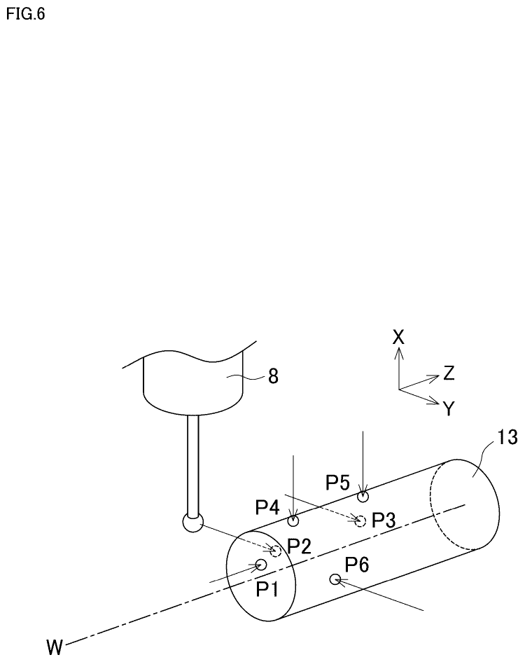

A description will be given of the case where the reference workpiece 13 has a columnar shape. FIG. 6 illustrates a schematic diagram of measurement positions of the columnar-shaped reference workpiece at the workpiece grasping preparation position 14. When the reference workpiece 13 has a columnar shape, the touch trigger probe 8 is brought into contact with a total of six points that are a contact point P1 to a contact point P6 as illustrated in FIG. 6, and contact point positions in respective contact directions are measured. However, the same value as that at a command position is obtained for two directions other than the contact directions. Here, when the diameter of the reference workpiece 13 is precisely known, the contact point P6 is not necessarily measured.

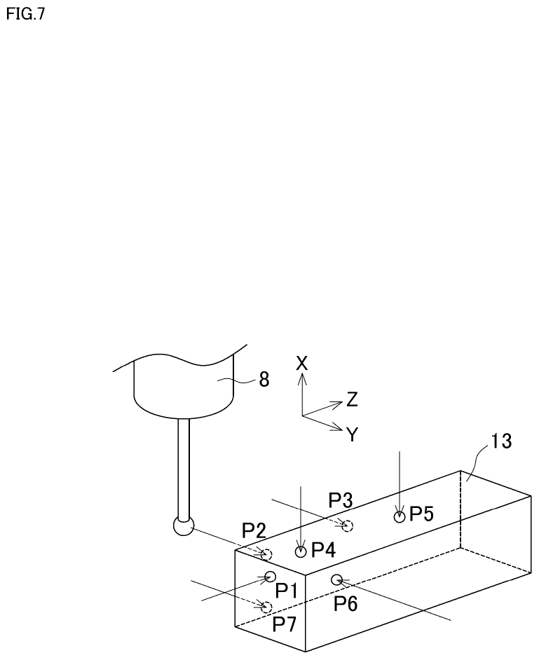

A description will be given of the case where the reference workpiece 13 has a regular quadrangular prism shape. FIG. 7 illustrates a schematic diagram of measurement positions of the prism-shaped reference workpiece at the workpiece grasping preparation position 14. When the reference workpiece 13 has a regular quadrangular prism shape, the touch trigger probe 8 is brought into contact with a total of seven points that are a contact point P1 to a contact point P7 as illustrated in FIG. 7, and respective contact point positions are measured.

Here, when a dimension of a width D′ of the reference workpiece 13 is precisely known, the contact point P6 is not necessarily measured.

At Step S5, an error of the position and posture of the reference workpiece 13 is calculated from the contact point positions measured at Step S4 (a first reference object position error calculating step).

A description will be given of the case where the reference workpiece 13 has a columnar shape. When a position measurement value at a contact point Pi (i=1 to 6) is assumed to be (pxi, pyi, pzi), a tilt error dAw about the X-axis of the reference workpiece 13 is obtained by the following formula (1). A tilt error dBw about the Y-axis is obtained by the formula (2).

$$dAw = ( py 3 - py 2 ) / ( pz 3 - pz 2 ) \qquad ( 1 )$$

$$dBw = ( px 5 - px 4 ) / ( pz 5 - pz 4 ) \qquad ( 2 )$$

Furthermore, an X-direction error dXw at the center of the bottom surface of the reference workpiece 13 is obtained by the following formula (3). A Y-direction error dYw at the center of the bottom surface of the reference workpiece 13 is obtained by the following formula (4). Here, the center positions X, Y of the turning main spindle 3 are x0, y0, respectively.

$$dXw = px 4 - ( py 2 - py 6 ) / 2 - x 0 \qquad ( 3 )$$

$$dYw = ( py 2 + py 6 ) / 2 - y 0 \qquad ( 4 )$$

As described above, when the diameter D of the reference workpiece 13 is precisely known, the measurement of the contact point P6 in not necessary. In the case, the X-direction error dXw at the center of the bottom surface of the reference workpiece 13 is obtained by the following formula (5). The Y-direction error dYw at the center of the bottom surface of the reference workpiece 13 is obtained by the following formula (6).

$$dXw = px 4 - D / 2 - x 0 \qquad ( 5 )$$

$$dYw = py 2 + D / 2 - y 0 \qquad ( 6 )$$

A Z-direction error dZw on an end surface of the reference workpiece 13 is obtained by the following formula (7). Here, a distance from a Z-direction position on an end surface of the chuck 4 to an assumed Z-direction position of the workpiece grasping preparation position 14 is z0.

$$d Z w = pz 1 - z 0 \qquad ( 7 )$$

Subsequently, a description will be given of the case where the reference workpiece 13 has a regular quadrangular prism shape. Basically, dXw, dYw, dZw, dAw, and dBw are obtained by calculations similarly to the case of the columnar shape. On the other hand, a tilt error dCw about the Z-axis is obtained by the following formula (8).

$$dCw = ( py 2 - py 7 ) / ( px 2 - px 7 ) \qquad ( 8 )$$

The shape of the reference workpiece 13 is not limited to the columnar shape or the regular quadrangular prism shape, and may be a shape having a polyhedron or a shape having a plurality of spheres. In the measurements of a spherical shape, contacts at four positions or more allows for a measurement of a center position of the sphere, and the error of the position and posture of the reference workpiece 13 are obtained from the center positions of three or more spheres.

At Step S6, it is determined whether or not the error of the position and posture of the reference workpiece 13 obtained at Step S5 is equal to or less than a predetermined threshold. When the error of the position and posture of the reference workpiece 13 is equal to or less than the threshold, the position adjustment of the manipulator 10 is terminated as the error is small.

On the other hand, when the error of the position and posture of the reference workpiece 13 is larger than the threshold, a compensation is performed at Step S7 (a first manipulator position compensating step). In the case, Step S3 to Step S7 are repeatedly executed until the error of the position and posture of the reference workpiece 13 becomes equal to or less than the threshold. The position adjustment of the manipulator 10 may be terminated when the steps are repeated a certain number of times.

At Step S7, the command of the position and posture of the end effector 11 is compensated such that the error of the position and posture of the reference workpiece 13 obtained at Step S5 is canceled. Examples of the compensation method include a method in which a local coordinate system is set during the teaching of the workpiece grasping preparation position 14 of the manipulator 10, and the local coordinate system is compensated. As another method, there is, for example, a method in which the teaching data during the teaching of the workpiece grasping preparation position 14 is compensated.

Thus, in the first position adjustment method of the manipulator, the position and/or the posture of the reference workpiece 13 carried in by the manipulator 10 is measured using the touch trigger probe 8, and the position and/or the posture of the manipulator 10 is adjusted based on the measurement result. Accordingly, a special device, such as a special sensor unit and camera, is not used. Therefore, the position adjustment of the manipulator 10 is executable by using the touch trigger probe 8, which is an accessory of a machine tool 1 and is a relatively low-priced contact-type sensor.

Furthermore, in the first position adjustment method of the manipulator, the position of the touch trigger probe 8 positioned with high positioning accuracy of the machine tool 1 is used as a reference, the position and posture of the reference workpiece 13 are calculated, and thus, the position and posture of the workpiece are adjustable with high accuracy. In the first position adjustment method of the manipulator, the measurement using the touch trigger probe 8 can be automatically performed, and therefore, it is also possible to automatically adjust the position of the workpiece.

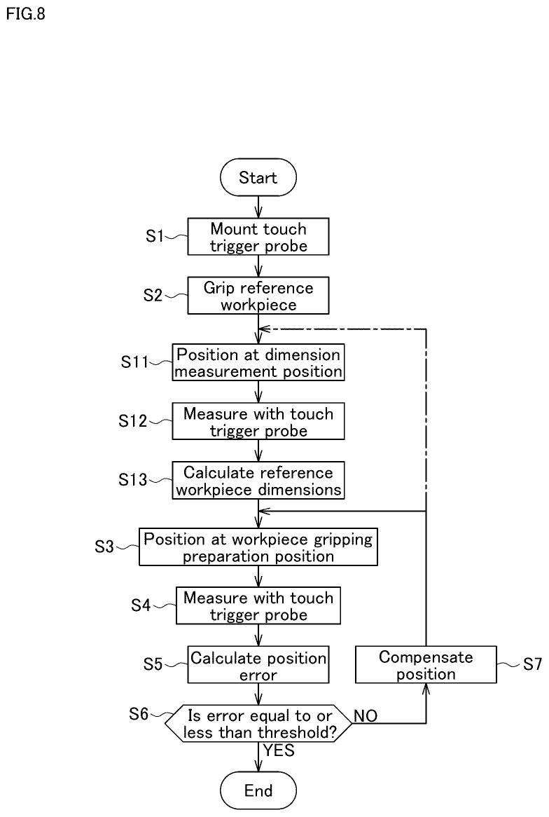

Next, a description will be given of a second position adjustment method of the manipulator using the flowchart in FIG. 8. The method is a method executed when the dimensions of the reference workpiece 13 are not precisely known, and the contact point P6 is not measurable due to interference between the touch trigger probe 8 or the tool rest 2A and a structural body or the end effector 11, or a restriction of an operating range of a feed axis. It should be noted that the steps overlapping with the first position adjustment method of the manipulator illustrated in FIG. 4 will not be further elaborated here.

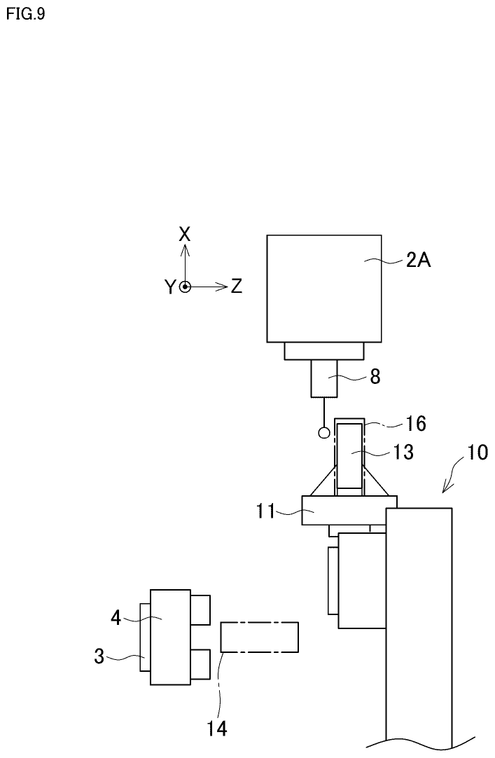

FIG. 9 illustrates a schematic diagram in which the reference workpiece 13 is disposed at a dimension measurement position.

At Step S11 after Step S1 and Step S2 are executed, the manipulator 10 is positioned such that the reference workpiece 13 gripped by the end effector 11 is disposed at a preset position (referred to as a “dimension measurement position 16”) different from the workpiece grasping preparation position 14 as illustrated in FIG. 9 (a second reference object positioning step).

At Step S12, a plurality of positions of the reference workpiece 13 positioned at the dimension measurement position 16 are measured using the touch trigger probe 8 (a second reference object position measuring step).

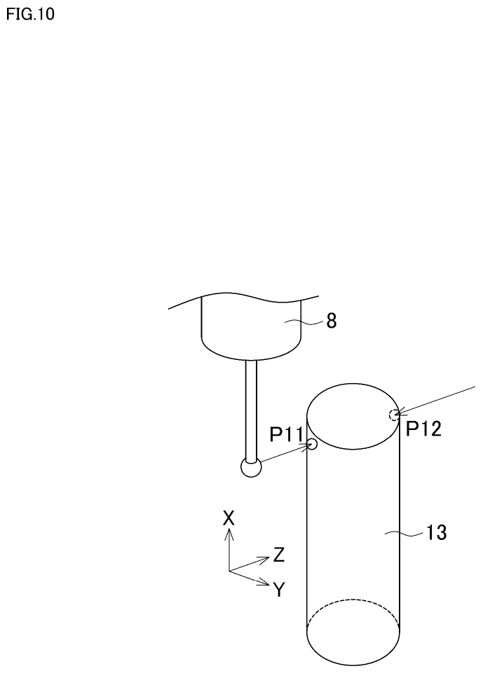

A description will be given of the case where the reference workpiece 13 has a columnar shape. FIG. 10 illustrates a schematic diagram of a measurement position of the columnar-shaped reference workpiece at the dimension measurement position 16. When the reference workpiece 13 has a columnar shape, the touch trigger probe 8 is brought into contact with contact points P11, P12 as illustrated in FIG. 10, and respective contact point positions are measured.

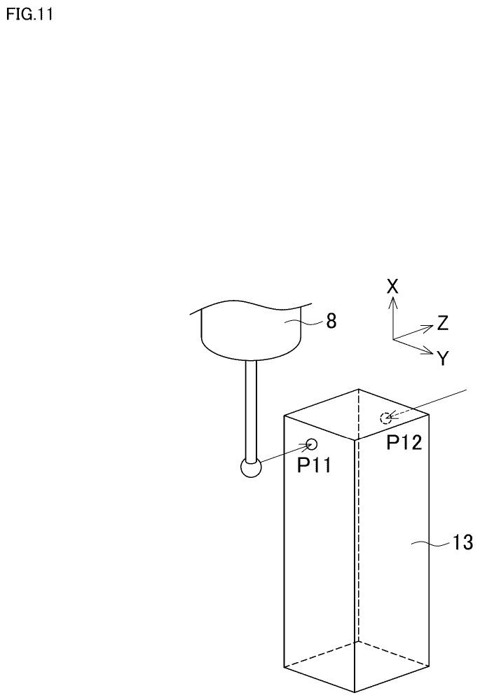

A description will be given of the case where the reference workpiece 13 has a regular quadrangular prism shape. FIG. 11 is a schematic diagram of a measurement position of the regular-quadrangular-prism-shaped reference workpiece at the dimension measurement position 16. When the reference workpiece 13 has a regular quadrangular prism shape, the touch trigger probe 8 is brought into contact with the contact points P11, P12 as illustrated in FIG. 11, and respective contact point positions are measured.

At Step S13, the dimensions of the reference workpiece 13 are calculated from the contact point positions measured at Step S12 (a first reference object dimension measuring step).

When the reference workpiece 13 has a columnar shape, the diameter D of the reference workpiece 13 is obtained by the following formula (9) when a position measurement value at a contact point Pi (i=11, 12) is (pxi, pyi, pzi).

$$D = pz 12 - pz 11 \qquad ( 9 )$$

When the reference workpiece 13 has a regular quadrangular prism shape, a width D′ of the reference workpiece 13 is similarly obtained by the above-described formula (9).

Subsequently, Step S3 to Step S7 are executed similarly to the first position adjustment method of the manipulator. In the second position adjustment method of the manipulator, when the error of the position and posture of the reference workpiece 13 is larger than a threshold in a threshold determination of the error of the position and posture of the reference workpiece 13 at Step S6, Step S3 to Step S7 are repeatedly executed until the error of the position and posture of the reference workpiece 13 becomes less than or equal to the threshold similarly to the first position adjustment method of the manipulator. At this time, the second position adjustment method of the manipulator may conveniently include and execute Step S11 to Step S13.

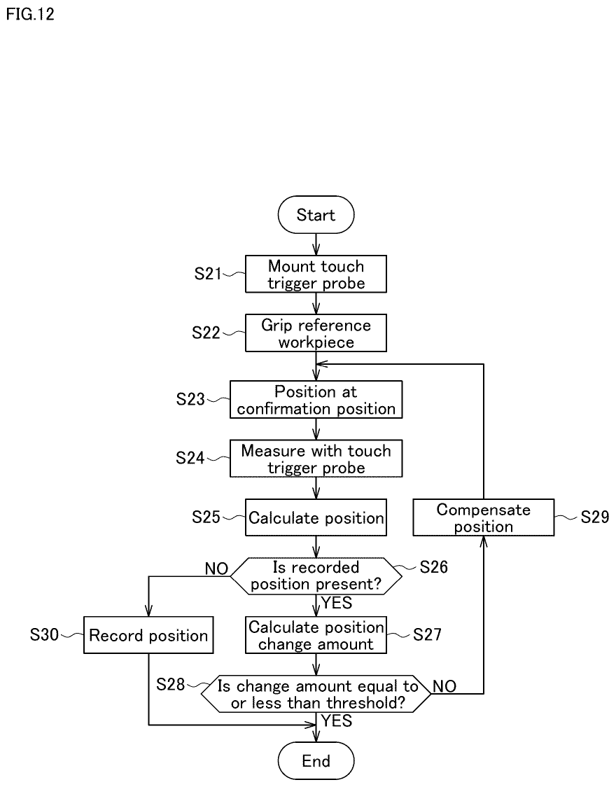

Next, a third position adjustment method of the manipulator will be described using the flowchart in FIG. 12. The third position adjustment method of the manipulator is a method for a case where a position measurement at the workpiece grasping preparation position 14 cannot be performed because the reference workpiece 13 cannot be positioned at the workpiece grasping preparation position 14. The reason why the reference workpiece 13 cannot be positioned at the workpiece grasping preparation position 14 is considered that at least one of the touch trigger probe 8 and the tool rest 2A interferes with other structural body such as the end effector 11. The third position adjustment method of the manipulator is executed on the premise that the adjustment of the workpiece grasping preparation position 14 is executed at least once.

At Step S21, the touch trigger probe 8 is mounted on the tool rest 2A. At Step S22, the reference workpiece 13 is gripped by the end effector 11 of the manipulator 10. The reference workpiece 13 may be secured to the end effector 11. The end effector 11 having a part corresponding to the reference workpiece 13 may be used.

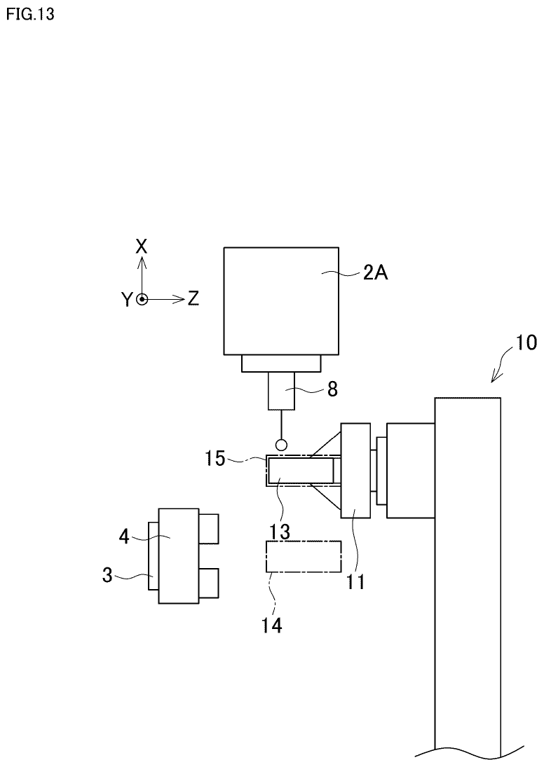

FIG. 13 illustrates a schematic diagram of a positional relationship of the reference workpiece at a confirmation measurement position. At Step S23, the manipulator 10 is positioned such that the reference workpiece 13 is positioned at a preset position (referred to as a “workpiece confirmation position 15”) different from the workpiece grasping preparation position 14 as illustrated in FIG. 13 (a first confirmation positioning step).

At Step S24, a plurality of positions of the reference workpiece 13 positioned at the workpiece confirmation position 15 are measured using the touch trigger probe 8 (a first confirmation measurement step). The positions to measure are similar to those in Step S4.

At Step S25, the position and posture of the reference workpiece 13 are calculated from the contact point positions measured at Step S24 (a first confirmation position calculating step). The calculation method is similar to that in Step S5, x0, y0, and z0 in the above-described formula (3) to formula (7) are calculated as 0. The error values may be calculated as Step S5.

At Step S26, it is determined whether or not the position and posture of the reference workpiece 13 obtained at Step S25 are recorded. When Step S23 to Step S25 are executed for the first time immediately after the adjustment of the workpiece grasping preparation position 14, the position and the posture of the reference workpiece 13 are not recorded. In the case, at Step S30, the position and posture of the reference workpiece 13 obtained at Step S25 are recorded, and the position adjustment of the manipulator 10 is terminated.

On the other hand, when the position and posture of the reference workpiece 13 are determined to be recorded, at Step S27, a difference value between the calculated value of the position and posture of the reference workpiece 13 at S25 and the recorded value is calculated as an amount of change in the position and posture of the reference workpiece 13 (a first position change amount calculating step).

At Step S28, it is determined whether or not the amount of change calculated at Step S27 is less than or equal to a predetermined threshold.

When the amount of change calculated at Step S27 is less than or equal to the predetermined threshold, the position adjustment of the manipulator 10 is terminated as the amount of change is small. Here, the recorded value may be updated using the calculated value of the position and posture of the reference workpiece 13. On the other hand, when the amount of change calculated at Step S27 is larger than the thresholds, the position is compensated at Step S29 (a first confirmation position compensating step). In the case, Step S23 to Step S28 are repeatedly executed until the amount of change calculated at Step S27 becomes equal to or less than the threshold. The position adjustment of the manipulator 10 may be terminated when the steps are repeated a certain number of times.

At Step S29, the command of the position and posture of the end effector 11 is compensated so as to cancel the amount of change in the position and posture of the reference workpiece 13 obtained at Step S27. Examples of the compensation method include a method that sets a local coordinate system during the teaching of the workpiece grasping preparation position 14 of the manipulator 10, and compensates the local coordinate system. Another method is a method that, for example, compensates the teaching data during the teaching of the workpiece grasping preparation position 14.

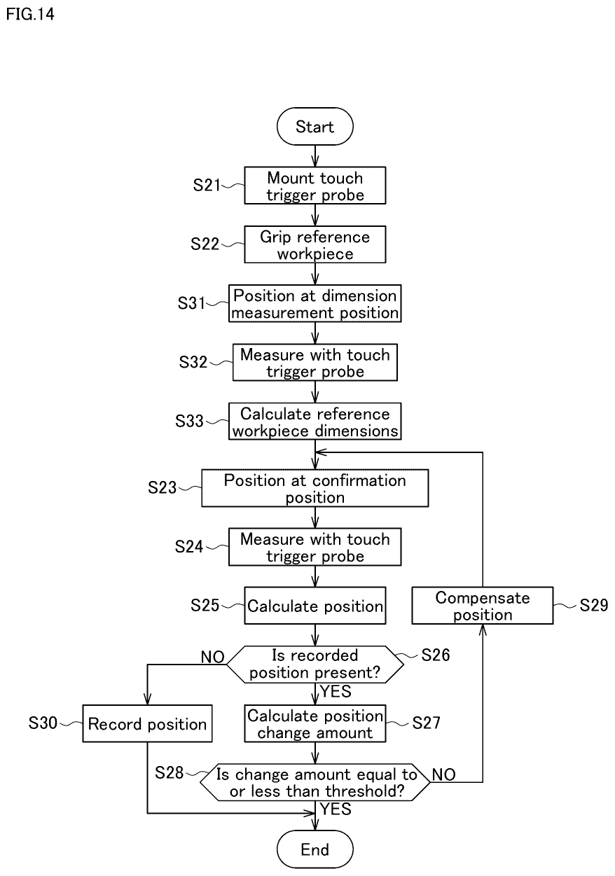

Next, a fourth position adjustment method of the manipulator will be described using the flowchart in FIG. 14. The fourth position adjustment method of the manipulator is a method for a case where the dimensions of the reference workpiece 13 is not precisely known and the contact point P6 cannot be measured. The reason why the contact point P6 cannot be measured is considered that at least one of the touch trigger probe 8 and the tool rest 2A interferes with other structural body such as the end effector 11. It should be noted that the steps overlapping with the third position adjustment method of the manipulator illustrated in FIG. 12 will not be further elaborated here.

After Step S21 and Step S22 are executed, at Step S31, the manipulator 10 is positioned such that the reference workpiece 13 gripped by the end effector 11 has, for example, the position and posture as the dimension measurement position 16 illustrated in FIG. 9, which are the position and posture different from the workpiece confirmation position 15 (a second confirmation positioning step).

At Step S32, similarly to Step S12, a plurality of positions of the reference workpiece 13 positioned at the dimension measurement position 16 are measured using the touch trigger probe 8 (a second confirmation position measuring step).

At Step S33, similarly to Step S13, dimensions of the reference workpiece 13 are calculated from the contact point positions measured at Step S32 (a second reference object dimension measuring step).

Further using thus measured dimensions of the reference workpiece 13, the position and posture of the reference workpiece 13 gripped by the end effector 11 are calculated through the first confirmation positioning step (S23), the first confirmation measurement step (S24), and the first confirmation position calculating step (S25).

Thereafter, S23 to S29 are executed as necessary, and the position of the manipulator 10 is adjusted.

While in the above-described first to fourth position adjustment methods of the manipulator, the machine tool 1 configured to perform the translational motion of three degrees of freedom has been described as an example, the following will describe a machine tool having two or less degree of freedom of the translational motion as an example.

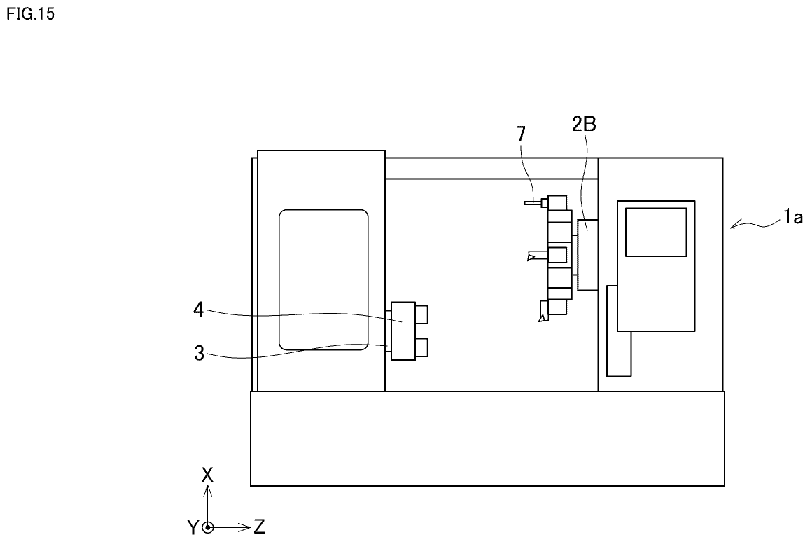

FIG. 15 illustrates a schematic diagram of a two-axis horizontal lathe 1a as the machine tool having two or less degree of freedom of the translational motion. As illustrated in FIG. 15, the tool 7, such as an end mill as a rotating tool or a single point tool as a non-rotating tool, is mountable on the tool rest 2B. A translational motion of two degrees of freedom at the X-axis and the Z-axis, which are mutually orthogonal, is possible. The chuck 4 has a plurality of openable/closable jaws that are configured to grasp the workpiece and the chuck 4 is rotatable by the turning main spindle 3. The driving mechanism, such as a feed axis and a motor relating to the operations of the respective portions, in the two-axis horizontal lathe 1a is controlled by the numerical control device NC1, which is not illustrated in the drawing. The machine tool having the tool rest whose degree of freedom of the translational motion is two degrees of freedom or less according to the disclosure is not limited to the two-axis horizontal lathe 1a, and may, for example, be a machining center having a tool rest whose degree of freedom of the translational motion is two degrees of freedom or less.

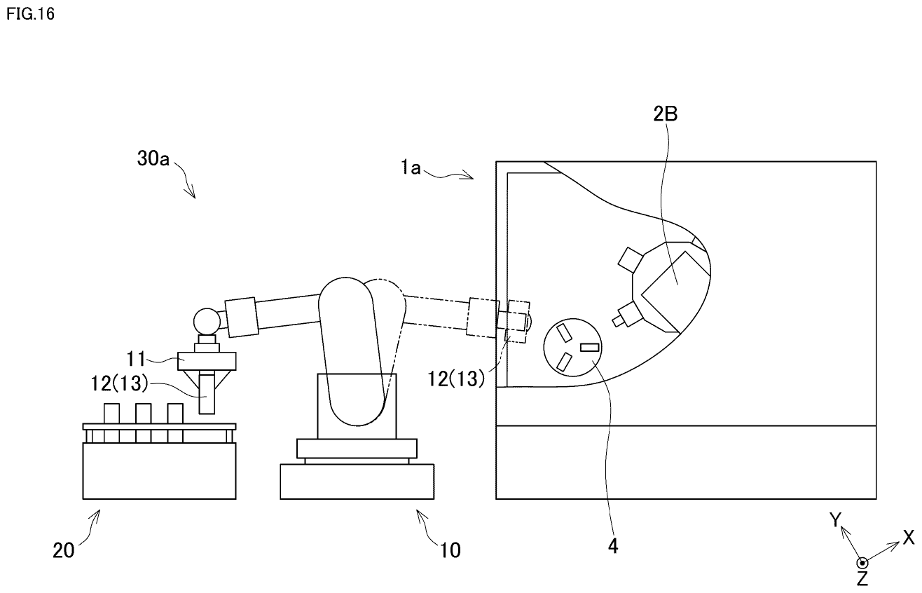

FIG. 16 is a schematic diagram of a machining cell, and illustrates an exemplary machining cell according to the two-axis horizontal lathe 1a. As illustrated in FIG. 16, a machining cell 30a includes the two-axis horizontal lathe 1a, the manipulator 10, and the workpiece stocker 20. The manipulator 10 and the workpiece stocker 20 are similar to those illustrated in FIG. 1, and as described above.

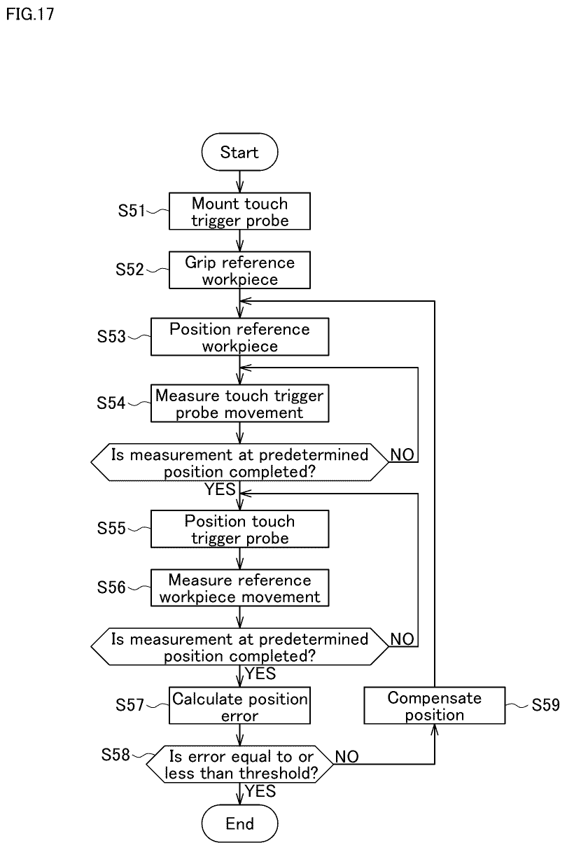

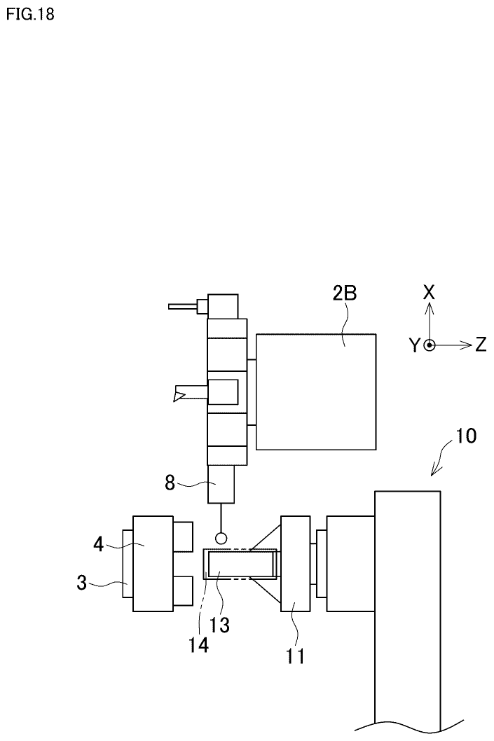

Using the flowchart in FIG. 17, and the schematic diagram of the positional relationship of the workpiece grasping preparation position 14 in FIG. 18, a position adjustment method of the manipulator 10 in the two-axis horizontal lathe 1a as a fifth position adjustment method of the manipulator will be described below.

At Step S51, the touch trigger probe 8 is mounted on the tool rest 2B as illustrated in FIG. 18. The two-axis horizontal lathe 1a has two translational drive axes, which are the X-axis and the Z-axis, and therefore, a two-dimensional position on the XZ-plane is measurable.

At Step S52, the reference workpiece 13 is gripped by the end effector 11 of the manipulator 10. Here, the reference workpiece 13 may be secured to the end effector 11. The end effector 11 having a portion corresponding to the reference workpiece 13 may be used.

At Step S53, the manipulator 10 is positioned such that the reference workpiece 13 gripped by the end effector 11 is positioned at the workpiece grasping preparation position 14 inside the machine of the two-axis horizontal lathe 1a as illustrated in FIG. 18 (a third reference object positioning step).

At Step S54, the tool rest 2B is moved such that the touch trigger probe 8 mounted on the tool rest 2B is brought into contact with the reference workpiece 13, and an output signal when the touch trigger probe 8 and the measurement target object are brought into contact is received by the numerical control device NC1 of the two-axis horizontal lathe 1a. Subsequently, the numerical control device NC1 obtains respective positions of the translational drive axes when the signal is received or when delay is taken into account. The numerical control device NC1 performs computations by considering a preset compensation value based on the obtained respective positions of the translational drive axes, and measures contact point positions in the axial directions of the translational drive axes (a first machine tool position measuring step). S54 as the first machine tool position measuring step is repeatedly executed until the measurement termination at the predetermined positions set in advance is confirmed.

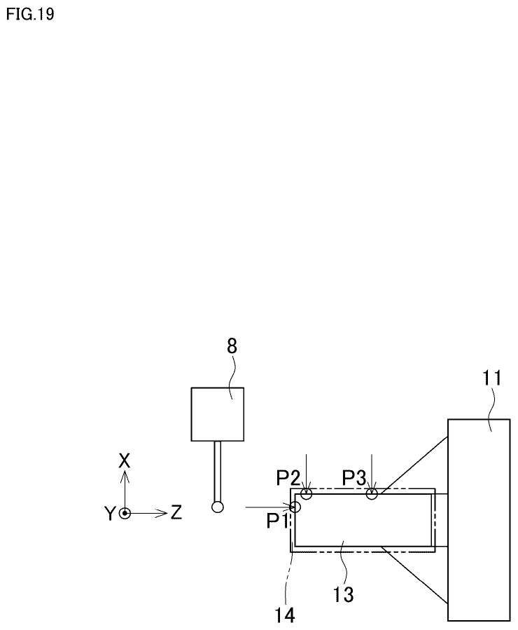

A description will be given of the case where the reference workpiece 13 has a columnar shape. FIG. 19 is a schematic diagram of measurements of a columnar-shaped reference workpiece at the workpiece grasping preparation position 14, and is a movement explanatory drawing of the touch trigger probe 8.

When the reference workpiece 13 has a columnar shape, the touch trigger probe 8 is moved in a Z positive direction and brought into contact with a point on a columnar bottom surface of the reference workpiece 13 as illustrated in FIG. 19, and a contact point P1 (Xp1, zp1) is obtained.

Furthermore, the touch trigger probe 8 is moved in an X negative direction and brought into contact with points on a side surface of the reference workpiece 13, and a contact point P2 (xp2, Zp2) and a contact point P3 (xp3, Zp3) are obtained. Here, Xp1, Zp2, and Zp3 are command values.

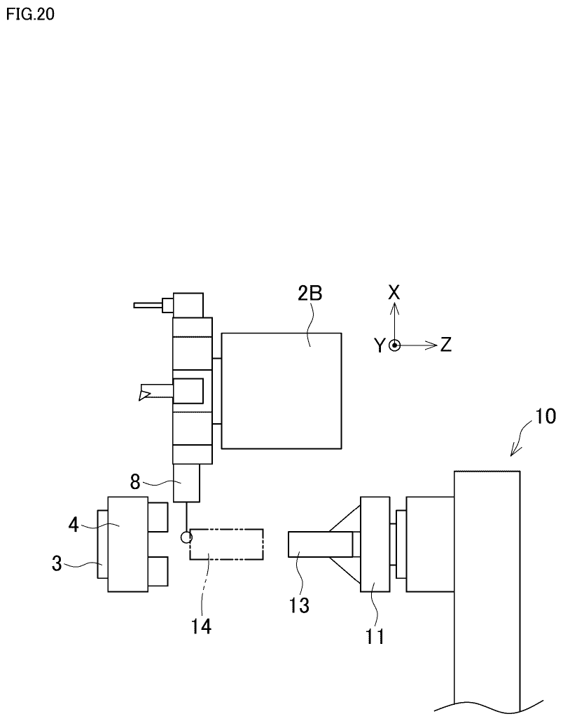

FIG. 20 is a schematic diagram of measurements of a columnar-shaped reference workpiece at the workpiece grasping preparation position 14 and is an explanatory drawing with an addition of the tool rest 2B.

At Step S55, the tool rest 2B is positioned such that the touch trigger probe 8 is positioned in the proximity of the workpiece grasping preparation position 14 as illustrated in FIG. 20 (a first sensor positioning step).

At Step S56, the manipulator 10 is moved such that the reference workpiece 13 gripped by the end effector 11 is brought into contact with the touch trigger probe 8 positioned in the proximity of the workpiece grasping preparation position 14. The signal output by the touch trigger probe 8 detecting the contact is received by the numerical control device NC2 of the manipulator 10, not the machine tool 1. Subsequently, the numerical control device NC2 obtains respective positions of joint driving axes when the signal is received or when delay is taken into account. The numerical control device NC2 performs computations by considering a forward kinematics calculation, a deformation error due to the gravity, and a preset compensation value based on the obtained positions of the joint driving axes, and obtains a position and posture of the manipulator 10 at the contact points (a first manipulator position measuring step). S56 as the first manipulator position measuring step is repeatedly executed until the measurement termination at the predetermined positions set in advance is confirmed.

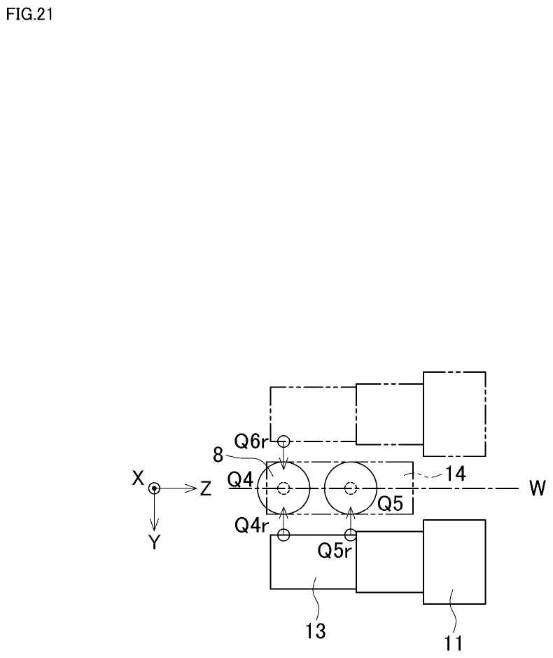

FIG. 21 is a schematic diagram of a measurement of the columnar-shaped reference workpiece 13 at the workpiece grasping preparation position 14, and is an explanatory drawing of moving the reference workpiece 13. When the reference workpiece 13 has a columnar shape, the measurement of the reference workpiece 13 firstly start with positioning the touch trigger probe 8 at Q4 (Xq4, Yq4, Zq4) on a columnar central axis w of the workpiece grasping preparation position 14 as illustrated in FIG. 21. Thereafter, the reference workpiece 13 is moved in both a Y negative direction and a Y positive direction as illustrated in FIG. 21 so as to bring the touch trigger probe 8 into contact with the side surface of the reference workpiece 13, and thus, a position and posture Q4r (xr4, yr4, zr4, ar4, br4, cr4) at a Y positive direction contact point with respect to the Q4 and a position and posture Q6r (xr6, yr6, zr6, ar6, br6, cr6) at a Y negative direction contact point are obtained.

Subsequently, the touch trigger probe 8 is positioned at Q5 (Xq5, Yq5, Zq5) on the columnar central axis w of the workpiece grasping preparation position 14. The reference workpiece 13 is then moved in the Y negative direction as illustrated in FIG. 21, so as to bring the touch trigger probe 8 into contact with the side surface of the reference workpiece 13, and a position and posture Q5r (xr5, yr5, zr5, ar5, br5, cr5) at the contact point with respect to Q5 is obtained. When the diameter D of the reference workpiece 13 is precisely known, a measurement at Q6r is not necessarily performed.

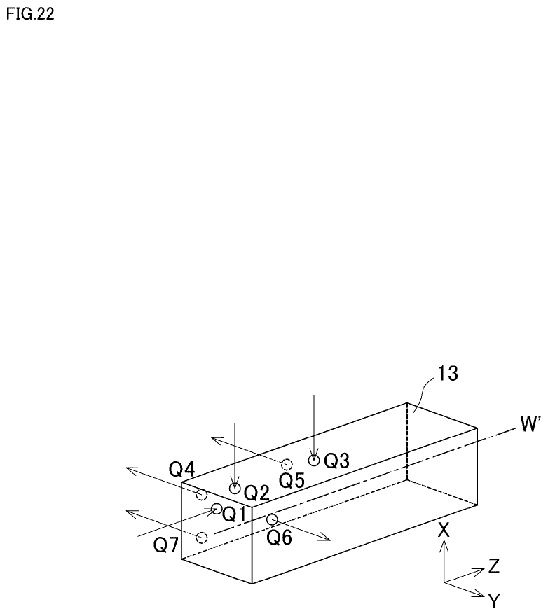

Next, a description will be given of the case where the reference workpiece 13 has a regular quadrangular prism shape. FIG. 22 illustrates a schematic diagram of a measurement position of the prism-shaped reference workpiece at the workpiece grasping preparation position 14.

When the reference workpiece 13 has a regular quadrangular prism shape, as illustrated in FIG. 22, a total of three positions that are Q4 on the plane in a Z negative direction, and Q2, Q3 on the plane in an X positive direction of the reference workpiece 13, are measured at Step S53 and Step S54. At Step S55 and Step S56, a total of four positions that are Q4, Q5, Q7, on the plane in the Y negative direction, and Q6 on the plane in the Y positive direction of the reference workpiece 13 are measured.

Here, Q4 is a position shifted in the X positive direction with respect to a center axis W′ of the reference workpiece 13 having the regular quadrangular prism shape. Q7 is a position shifted in the X negative direction with respect to the center axis W′ of the reference workpiece 13 having the regular quadrangular prism shape. The measurement at Q7 obtains a position and posture Q7r (xr7, yr7, zr7, ar7, br7, cr7) of the contact point. When the width D′ in the Y-direction of the reference workpiece 13 is precisely known, the measurement at Q6r is not necessarily performed.

Next, at Step S57, an error of the position and posture of the reference workpiece 13 is calculated (a second reference object position error calculating step).

First, a description will be given of the case where the reference workpiece 13 has a columnar shape. The tilt error dAw about the X-axis of the reference workpiece 13 is obtained by the following formula (10). The tilt error dBw about the Y-axis of the reference workpiece 13 is obtained by the following formula (11).

$$dAw = ( yr 4 - yr 5 ) / ( Zq 5 - Zq 4 ) \qquad ( 10 )$$

$$dBw = ( xp 3 - xp 2 ) / ( Zp 3 - Zp 2 ) \qquad ( 11 )$$

The X-direction error dXw at the center of the bottom surface of the reference workpiece 13 is obtained by the following formula (12). The Y-direction error dYw at the center of the bottom surface of the reference workpiece 13 is obtained by the following formula (13). Here, yen is a compensation value in the Y negative direction and ycp is a compensation value in the Y positive direction, which are for compensating a radius of the stylus ball of the touch trigger probe 8 and an error, such as displacement. In addition, d is an assumed diameter value of the reference workpiece 13 for calculating the contact points in the manipulator 10. Furthermore, the center positions X, Y of the turning main spindle 3 are x0, y0, respectively.

$$dXw = xp 2 - ( yr 4 + ycp - yr 6 - ycn + d ) / 2 - x 0 \qquad ( 12 )$$

$$dYw = - ( yr 6 + ycn + yr 4 + ycp ) / 2 - y 0 \qquad ( 13 )$$

As described above, when the diameter D of the reference workpiece 13 is precisely known, the measurement of the contact point P6 is not necessary, and the X-direction error dXw at the center of the bottom surface of the reference workpiece 13 is obtained by the following formula (14). The Y-direction error dYw at the center of the bottom surface of the reference workpiece 13 is obtained by the following formula (15).

$$dXw = px 4 - D / 2 - x 0 \qquad ( 14 )$$

$$dYw = - ( yr 4 - Yq 4 + ycp ) + D / 2 - y 0 \qquad ( 15 )$$

The Z-direction error dZw on the end surface of the reference workpiece 13 is obtained by the following formula (16). Here, a distance from the Z-direction position on an end surface of the chuck 4 to the assumed Z-direction position of the workpiece grasping preparation position 14 is z0.

$$dZw = pz 1 - z 0 \qquad ( 16 )$$

Subsequently, a description will be given of the case where the reference workpiece 13 has a regular quadrangular prism shape. When the reference workpiece 13 has a regular quadrangular prism shape, calculations are basically similarly performed to the case of the columnar shape. The X-direction error dXw at the center of the bottom surface, the Y-direction error dYw at the center of the bottom surface, the Z-direction error dZw on the end surface, the tilt error dAw about the X-axis, and the tilt error dBw about the Y-axis of the reference workpiece 13 are obtained by the above-described formula (10) to formula (16), respectively. However, the diameter D, the assumed diameter value d in the above-described formula (10) to formula (16) are replaced by the width D′ and the assumed width dimension d′, respectively.

Furthermore, the tilt error dCw about the Z-axis is obtained by the following formula (17).

$$dCw = ( yr 7 - yr 2 ) / ( Xq 2 - Xq 7 ) \qquad ( 17 )$$

At Step S58, it is determined whether or not the error of the position and posture of the reference workpiece 13 obtained at Step S57 is equal to or less than a predetermined threshold. When the error of the position and posture of the reference workpiece 13 is less than or equal to the threshold, the position adjustment of the manipulator 10 is terminated as the error is small.

On the other hand, the error of the position and posture of the reference workpiece 13 is larger than the threshold, a compensation is performed at Step S59. In this case, Step S53 to Step S59 are repeatedly executed until the error of the position and posture of the reference workpiece 13 becomes less than or equal to the threshold. Note that the position adjustment of the manipulator 10 may be terminated when the steps are repeated a certain number of times.

At Step S59, the command of the position and posture of the end effector 11 is compensated so as to cancel the amount of change in the position and posture of the reference workpiece 13 obtained at Step S57 (a second manipulator position compensating step). Examples of the compensation method include a method that sets a local coordinate system during the teaching of the workpiece grasping preparation position 14 of the manipulator 10, and compensates the local coordinate system. Another method is a method that, for example, compensates the teaching data during the teaching of the workpiece grasping preparation position 14.

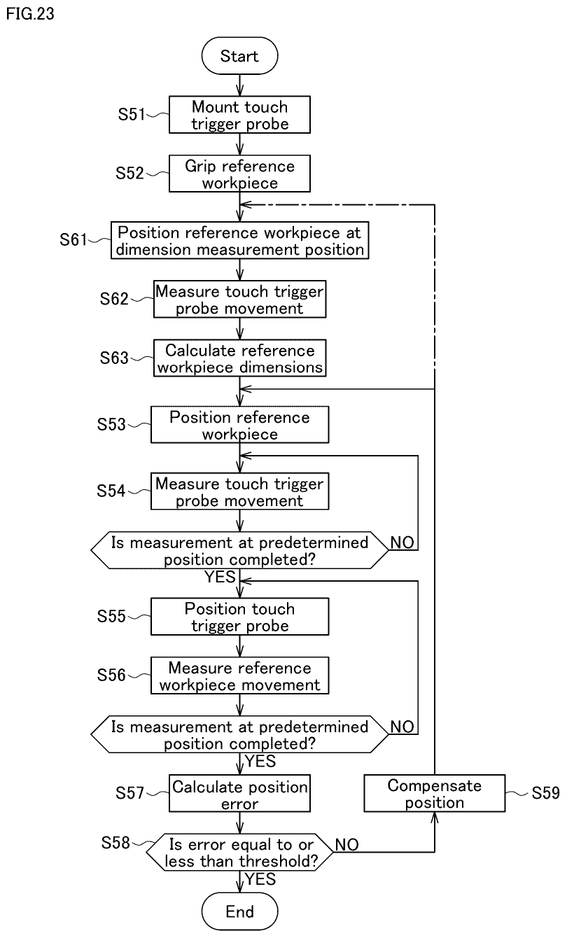

Next, a sixth position adjustment method of the manipulator will be described using the flowchart in FIG. 23. The sixth position adjustment method of the manipulator is a method for a case where the dimensions of the reference workpiece 13 is not precisely known and the contact point P6 cannot be measured. One of the reasons why the contact point P6 cannot be measured is considered that at least one of the touch trigger probe 8 and the tool rest 2B interferes with other structural body such as the end effector 11. Another reason is that an operating range of a feed axis is restricted. It should be noted that the steps overlapping with the fifth position adjustment method of the manipulator illustrated in FIG. 17 will not be further elaborated here.

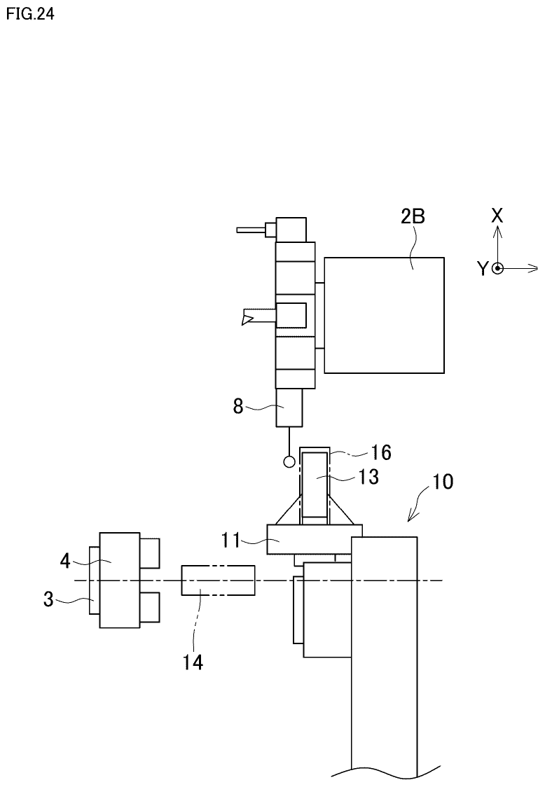

FIG. 24 illustrates a schematic diagram of a positional relationship of the dimension measurement position 16.

After Step S51 and Step S52 are executed, at Step S61, the manipulator 10 is positioned such that the reference workpiece 13 gripped by the end effector 11 has a position and posture different from the workpiece grasping preparation position 14 as illustrated in FIG. 24, for example, a position and posture as the dimension measurement position 16 illustrated in FIG. 9 (a fourth reference object positioning step).

At Step S62, the tool rest 2B is moved such that the touch trigger probe 8 is brought into contact with the reference workpiece 13 positioned at the dimension measurement position 16, and a plurality of positions of contact points of the reference workpiece 13 are measured similarly to Step S54.

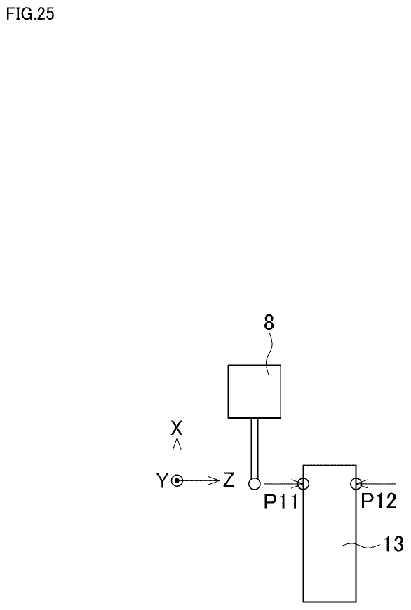

FIG. 25 illustrates a schematic diagram of measurements of the reference workpiece 13 at the dimension measurement position 16.

As illustrated in FIG. 25, the touch trigger probe 8 is moved in the Z positive direction so as to be brought into contact with a point on a side surface of the reference workpiece 13, and thus, a contact point P11 (Xp11, zp11) is obtained (a second machine tool position measuring step). Furthermore, the touch trigger probe 8 is moved in the Z negative direction so as to be brought into contact with a point on a side surface of the reference workpiece 13, and thus, a contact point P12 (Xp12, zp12) is obtained. Here, Xp11 and Xp12 are command values.

At Step S63, dimensions of the reference workpiece 13 are calculated from the contact point positions obtained at Step S62 (a third reference object dimension measuring step).

When the reference workpiece 13 has a columnar shape, the diameter D is obtained by the following formula (18). When the reference workpiece 13 has a regular quadrangular prism shape, the diameter D in the following formula (18) is replaced by the width D′.

$$D = pz 12 - pz 11 \qquad ( 18 )$$

Subsequently, Step S53 to Step S59 are executed similarly to the fifth position adjustment method of the manipulator. Note that, in the second position adjustment method of the manipulator, Step S53 to Step S59 are repeatedly executed until the error of the position and posture of the reference workpiece 13 becomes less than or equal to the threshold similarly to the fifth position adjustment method of the manipulator when the error of the position and posture of the reference workpiece 13 is larger than the threshold in the threshold determination of the error of the position and posture of the reference workpiece 13 at Step S58. However, the second position adjustment method of the manipulator may conveniently include and execute Step S61 to Step S63 at this time.

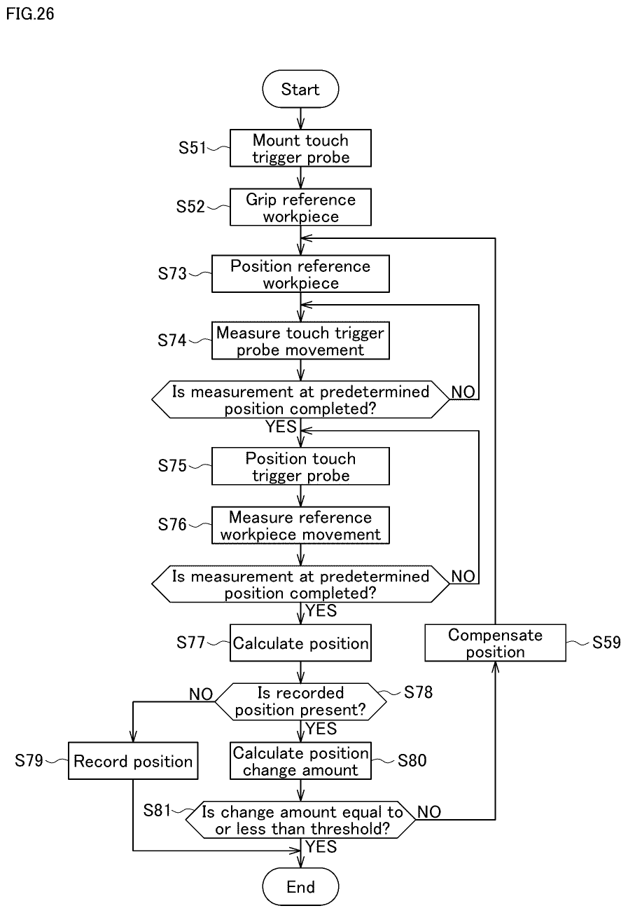

Next, a seventh position adjustment method of the manipulator will be described using the flowchart in FIG. 26. The seventh position adjustment method of the manipulator is executed on the premise that the adjustment of the workpiece grasping preparation position 14 is executed at least once. It should be noted that the steps overlapping with the fifth position adjustment method of the manipulator illustrated in FIG. 17 will not be further elaborated here.

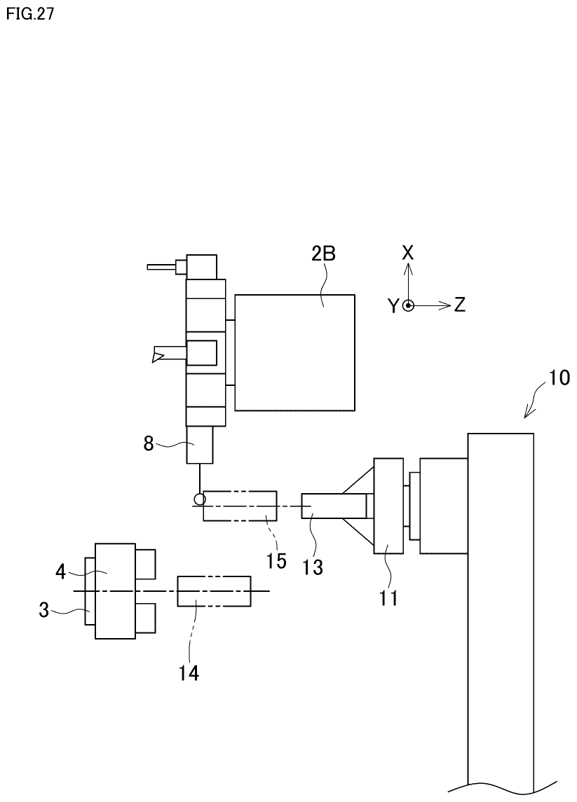

FIG. 27 is a schematic diagram of a positional relationship of the workpiece confirmation position 15.

After Step S51 and Step S52 are executed, at Step S73, the manipulator 10 is positioned such that the reference workpiece 13 gripped by the end effector 11 is positioned at the workpiece confirmation position 15 as illustrated in FIG. 27 (a third confirmation positioning step). Note that the manipulator 10 may be positioned such that the reference workpiece 13 is positioned at the workpiece grasping preparation position 14.

At Step S74, similarly to Step S54, the tool rest 2B is moved such that the touch trigger probe 8 is brought into contact with the reference workpiece 13, and thus, a position of a contact point is obtained (a third machine tool position measuring step). Similarly to Step S54, Step S74 is executed for a predetermined position. S74 as the third machine tool position measuring step is repeatedly executed until the measurement termination at the predetermined positions set in advance is confirmed.

At Step S75, the tool rest 2B is positioned such that the touch trigger probe 8 is positioned in the proximity of the workpiece confirmation position 15 similarly to Step S55 (a second sensor positioning step). The tool rest 2B may be positioned so as to be positioned in the proximity of the workpiece grasping preparation position 14.

At Step S76, similarly to Step S56, the manipulator 10 is moved such that the reference workpiece 13 is brought into contact with the touch trigger probe 8, and a position and posture of the contact point is obtained (a second manipulator position measuring step). S76 as the second manipulator position measuring step is repeatedly executed until the measurement termination at the predetermined positions set in advance is confirmed.

At Step S77, a position and posture of the reference workpiece 13 is calculated from a plurality of the obtained contact point positions (a second confirmation position calculating step). Similarly to Step S57, the error values may be calculated at Step S77 as well.

When the reference workpiece 13 has a columnar shape, an inclination pAw about the X-axis, an inclination pBw about the Y-axis, an X position pXw at the center of the bottom surface, a Y position pYw at the center of the bottom surface, and a Z position pZw on an end surface of the reference workpiece 13 are obtained by the following formula (19) to formula (23), respectively.

$$pAw = ( yr 4 - yr 5 ) / ( Zq 5 - Zq 4 ) \qquad ( 19 )$$

$$pBw = ( xp 3 - xp 2 ) / ( Zp 3 - Zp 2 ) \qquad ( 20 )$$

$$pZw = zr 1 \qquad ( 21 )$$

$$pXw = xp 2 - ( yr 4 + ycp - yr 6 - ycn + d ) / 2 \qquad ( 22 )$$

$$pYw = - ( yr 6 + ycn + yr 4 + ycp ) / 2 \qquad ( 23 )$$

When the diameter of the reference workpiece 13 is precisely known to be D, as described above, the measurement of the contact point P6 is not necessary, and the X position pXw at the center of the bottom surface is obtained by the following formula (24). The Y position pYw at the center on the bottom surface is obtained by the following formula (25).

$$pXw = xp 2 - D / 2 \qquad ( 24 )$$

$$pYw = - ( yr 4 + ycp ) + D / 2 \qquad ( 25 )$$

When the reference workpiece 13 has a regular quadrangular prism shape, similarly to the case of the columnar shape, the inclination pAw about the X-axis, the inclination pBw about the Y-axis, the X position pXw at the center of the bottom surface, the Y position pYw at the center of the bottom surface, and the Z position pZw on the end surface of the reference workpiece 13 are obtained by the above-described formula (19) to formula (25), respectively. However, the diameter D and the assumed diameter value d in the above-described formula (19) to formula (25) are replaced by the width D′ and the assumed width dimension d′, respectively.

Furthermore, an inclination pCw about the Z-axis is obtained by the following formula (26).

$$p C w = ( yr 7 - yr 2 ) / ( Xq 2 - Xq 7 ) \qquad ( 26 )$$

At Step S78, it is determined whether or not the position and posture of the reference workpiece 13 obtained at Step 77 is recorded. When Step S73 to Step S77 are executed for the first time immediately after the adjustment of the workpiece grasping preparation position 14, the position and posture of the reference workpiece 13 is not recorded. Therefore, at Step S79, the position and posture of the reference workpiece 13 is recorded, and the position adjustment of the manipulator 10 is terminated.

When the position and posture of the reference workpiece 13 is recorded, at Step S80, a difference value between the calculated value of the position and posture of the reference workpiece 13 and the recorded value is calculated as the amount of change in the position and posture of the reference workpiece 13 (a second position change amount calculating step).

At Step S81, it is determined whether or not the amount of change calculated at Step S80 is less than or equal to a predetermined threshold. When the amount of change calculated at Step S80 is less than or equal to the threshold, the position adjustment of the manipulator 10 is terminated as the amount of change is small. Here, the recorded value may be updated using the calculated value of the position and posture of the reference workpiece 13. On the other hand, when the amount of change calculated at Step S80 is larger than the threshold, the position compensation is performed at Step S59 (a second confirmation position compensating step). In the case, Step S59, Step S73 to Step S78, Step S80 to Step S81 are repeatedly executed until the amount of change calculated at Step S80 becomes less than or equal to the threshold. The position adjustment of the manipulator 10 may be terminated when the steps are repeated a certain number of times.

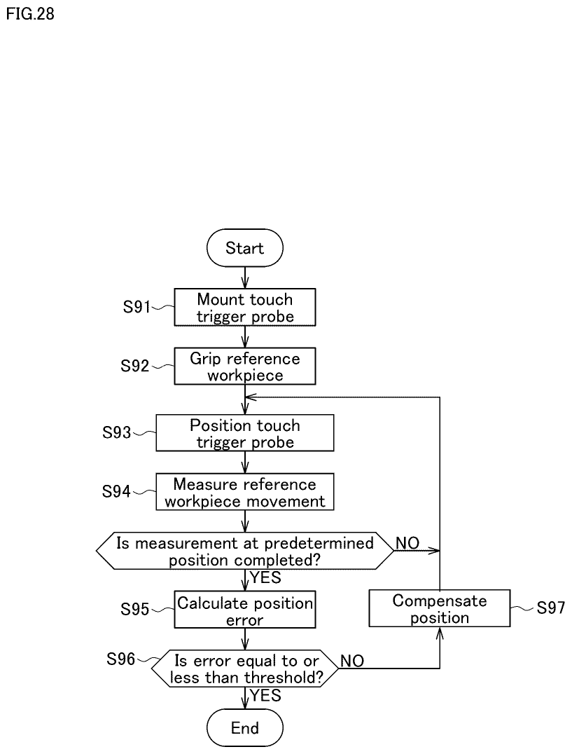

Next, an eighth position adjustment method of the manipulator will be described using the flowchart in FIG. 28.

At Step S91, the touch trigger probe 8 is mounted on the tool rest 2B.

At Step S92, the reference workpiece 13 is gripped by the end effector 11 of the manipulator 10. Here, the reference workpiece 13 may be secured to the end effector 11. The end effector 11 having a portion corresponding to the reference workpiece 13 may be used.

At Step S93, as illustrated in FIG. 20, the tool rest 2B is positioned such that the touch trigger probe 8 is positioned at the workpiece grasping preparation position 14 (a third sensor positioning step).

At Step S94, the manipulator 10 is moved such that the reference workpiece 13 gripped by the end effector 11 is brought into contact with the touch trigger probe 8 positioned at the workpiece grasping preparation position 14, and a signal output by the touch trigger probe 8 detecting the contact is received by the numerical control device NC2, not the machine tool 1. Subsequently, the numerical control device NC2 of the manipulator 10 obtains respective positions of joint driving axes when the signal is received or when delay is taken into account. The numerical control device NC2 performs computations by considering a forward kinematics calculation, a deformation error due to the gravity, and a preset compensation value based on the obtained positions of the joint driving axes, and obtains a position and posture of the manipulator 10 at the contact points (a third manipulator position measuring step). S94 as the third manipulator position measuring step is repeatedly executed until the measurement termination at the predetermined positions set in advance is confirmed.

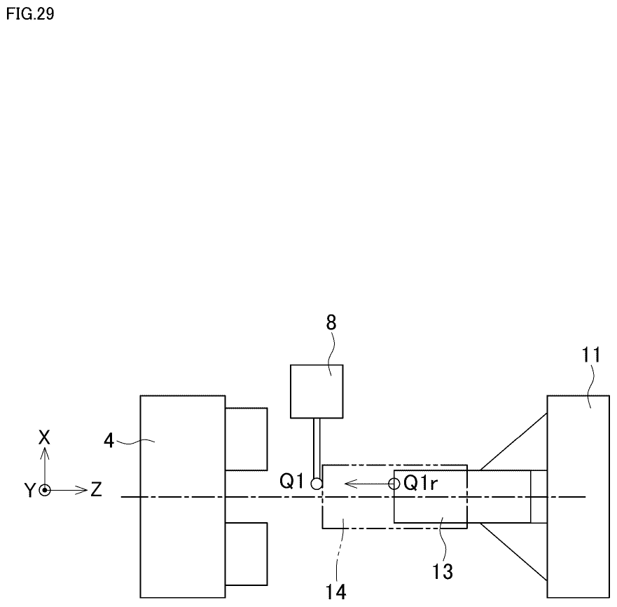

For Step S93 and Step S94, a description will be given of the case where the reference workpiece 13 has a columnar shape. FIG. 29 is a schematic diagram of measurement positions of the reference workpiece 13 having a columnar shape at the workpiece grasping preparation position 14, and is an explanatory drawing of moving the reference workpiece 13 in the Z-axis direction.

When the reference workpiece 13 has a columnar shape, the touch trigger probe 8 is positioned at Q1 (Xq1, Zq1) on the columnar bottom surface of the workpiece grasping preparation position 14 having a columnar shape as Step S93 as illustrated in FIG. 29. At Step S94, the reference workpiece 13 is moved in the Z negative direction so as to be brought into contact with the touch trigger probe 8, and Q1r (xr1, yr1, zr1, ar1, br1, cr1) as three position components and three posture components of the contact points at Q1 are respectively obtained from the positions of the joint driving axes of the manipulator 10.

Furthermore, Step S93 and Step S94 are executed for a total of six positions that are two positions in the X positive direction, two positions in the Y negative direction, and one position in the Y positive direction as follows.

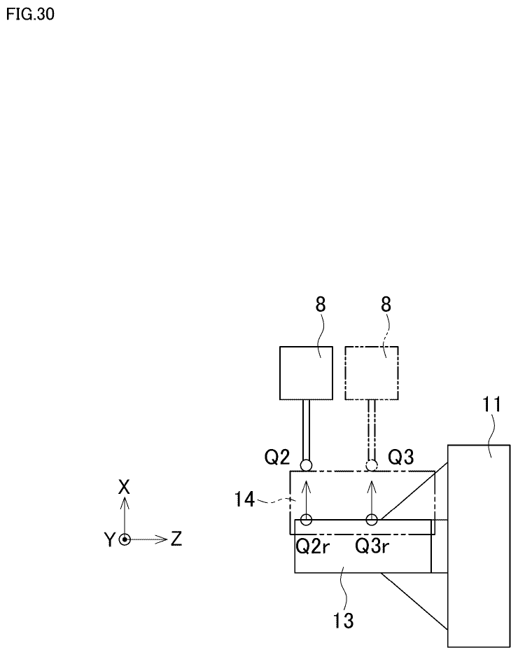

FIG. 30 is a schematic diagram of measurement positions of the columnar-shaped reference workpiece at the workpiece grasping preparation position 14, and is an explanatory drawing of moving the reference workpiece 13 in the X-axis direction. As illustrated in FIG. 30, the touch trigger probe 8 is positioned at Q2 (Xq2, Zq2), Q3 (Xq3, Zq3) in the X positive direction on a cylindrical side surface at the workpiece grasping preparation position 14 as Step S93. Subsequently, at S94, in each case where the touch trigger probe 8 is positioned at positions of Q2, Q3, the reference workpiece 13 is moved in the X positive direction and the touch trigger probe 8 is brought into contact with the side surface of the reference workpiece 13, and thus, a position and posture Q2r (xr2, yr2, zr2, ar2, br2, cr2) of the contact point with respect to Q2 and a position and posture Q3r (xr3, yr3, zr3, ar3, br3, cr3) of the contact point with respect to Q3 are obtained.

Furthermore, as illustrated in FIG. 21, the touch trigger probe 8 is positioned at Q4 (Xq4, Zq4) on the columnar central axis w of the workpiece grasping preparation position 14 as Step S93. Subsequently, as Step S94, the reference workpiece 13 is moved in each of the Y negative direction and the Y positive direction and the touch trigger probe 8 is brought into contact with the side surface of the reference workpiece 13, and thus, a position and posture Q4r (xr4, yr4, zr4, ar4, br4, cr4) of a Y positive direction contact point with respect to Q4 and a position and posture Q6r (xr6, yr6, zr6, ar6, br6, cr6) of a Y negative direction contact point are obtained.

As Step S93, the touch trigger probe 8 is positioned at Q5 (Xq5, Zq5) on the columnar central axis w of the workpiece grasping preparation position 14. Subsequently, as Step S94, the reference workpiece 13 is moved in the Y negative direction and the touch trigger probe 8 is brought into contact with the side surface of the reference workpiece 13, and thus, the position and posture Q5r (xr5, yr5, zr5, ar5, br5, cr5) of the contact point with respect to Q5 is obtained. Here, when the diameter D of the reference workpiece 13 is precisely known, the measurement of Q6r is not necessarily performed.

When the reference workpiece 13 has a regular quadrangular prism shape, as illustrated in FIG. 22, measurements are performed for a total of seven positions that are one position on a plane in the Z negative direction, two positions on a plane in the X positive direction, three positions on a plane in the Y negative direction, and one position on a plane in the Y positive direction. However, Q4 is a position shifted in the X positive direction with respect to the center axis W′ of the regular quadrangular prism, and Q7 is a position shifted in the X negative direction with respect to the center axis W′ of the regular quadrangular prism. In the measurement at Q7, a position and posture Q7r (xr7, yr7, zr7, ar7, br7, cr7) of the contact point is obtained.

Similarly to the case of the columnar shape, when the width D′ of the reference workpiece 13 is precisely known, the measurement of Q6r is not necessarily performed.

Next, at Step S95, an error of the position and posture of the reference workpiece 13 is calculated (a third reference object position error calculating step).

When the reference workpiece 13 has a columnar shape, the tilt error dAw about the X-axis of the reference workpiece 13 is obtained by the following formula (27). The tilt error dBw about the Y-axis is obtained by the following formula (28).

$$dAw = ( yr 4 - yr 5 ) / ( Zq 5 - Zq 4 ) \qquad ( 27 )$$

$$dBw = ( xr 2 - xr 3 ) / ( Zq 3 - Zq 2 ) \qquad ( 28 )$$

Furthermore, the X-direction error dXw at the center of the bottom surface of the reference workpiece 13 is obtained by the following formula (29). The Y-direction error dYw at the center of the bottom surface of the reference workpiece 13 is obtained by the following formula (30). Here, xen is a compensation value in the X negative direction, ycp is a compensation value in the Y positive direction, and yen is a compensation value in the Y negative direction. xcn, ycp, and yen are for compensating a radius of the stylus ball of the touch trigger probe 8 and an error, such as displacement. In addition, d is an assumed diameter value of the reference workpiece 13 for calculating the contact points in the manipulator 10.

$$dXw = - ( xr 2 - Xq 2 + x c n ) - ( yr 4 + ycp - yr 6 - ycn + d ) / 2 \qquad ( 29 )$$

$$dYw = - ( yr 6 + ycn + yr 4 + y cp ) / 2 \qquad ( 30 )$$

When the diameter D of the reference workpiece 13 is precisely known, the measurement of the posture Q6r is not necessary, and the X-direction error dXw at the center of the bottom surface of the reference workpiece 13 is obtained by the following formula (31). The Y-direction error dYw at the center of the bottom surface of the reference workpiece 13 is obtained by the following formula (32).

$$dXw = - ( xr 2 - Xq 2 + xcn ) - D / 2 \qquad ( 31 )$$

$$dYw = - ( yr 4 - Yq 4 + ycp ) + D / 2 \qquad ( 32 )$$

The Z-direction error dZw on the end surface of the reference workpiece 13 is obtained by the following formula (33). Here, zcp is a compensation value in the Z positive direction, and, for example, is for compensating the error in the Z positive direction of the touch trigger probe 8.

$$d Zw = zr 1 - Zq 1 + zcp \qquad ( 33 )$$

When the reference workpiece 13 has a regular quadrangular prism shape, basically similarly to the case of the columnar shape, the X-direction error dXw at the center of the bottom surface of the reference workpiece 13, the Y-direction error dYw at the center of the bottom surface of the reference workpiece 13, the Z-direction error dZw on the end surface, the tilt error dAw about the X-axis, and the tilt error dBw about the Y-axis are obtained by the above-described formula (27) to formula (33) respectively. However, the diameter D and the assumed diameter value d in the above-described formula (27) to formula (33) are replaced by the width D′ and the assumed width dimension d′, respectively.

Furthermore, the tilt error dCw about the Z-axis is obtained by the following formula (34).

$$dCw = ( yr 7 - yr 4 ) / ( Xq 4 - Xq 7 ) \qquad ( 34 )$$

At Step S96, it is determined whether or not the error of the position and posture of the reference workpiece 13 obtained at Step S95 is less than or equal to a predetermined threshold. When it is equal to or less than the threshold, the position adjustment of the manipulator 10 is terminated as the error is small.

On the other hand, when the error of the position and posture of the reference workpiece 13 is larger than the threshold, the compensation is performed at Step S97. In the case, Step S93 to Step S97 are repeatedly executed until the error of the position and posture of the reference workpiece 13 becomes equal to or less than the threshold. The position adjustment of the manipulator 10 may be terminated when the steps are repeated a certain number of times.

At Step S97, the command of the position and posture of the end effector 11 is compensated so as to cancel the error of the position and posture of the reference workpiece 13 obtained at Step S95 (a third manipulator position compensating step). Examples of the compensation method include a method that sets a local coordinate system during the teaching of the workpiece grasping preparation position 14 of the manipulator 10, and compensates the local coordinate system. Another method is a method that, for example, compensates the teaching data during the teaching of the workpiece grasping preparation position 14.

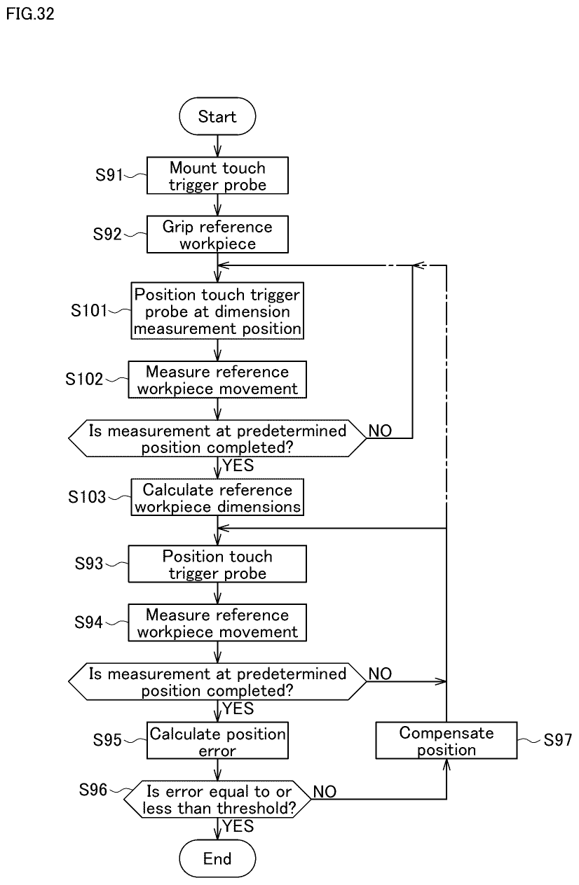

Next, a ninth position adjustment method of the manipulator will be described using the flowchart in FIG. 32. The ninth position adjustment method of the manipulator is a method for a case where the dimensions of the reference workpiece 13 is not precisely known and the contact point P6 cannot be measured. The reason why the contact point P6 cannot be measured is considered that at least one of the touch trigger probe 8 and the tool rest 2B interferes with other structural body such as the end effector 11. Another reason is that an operating range of a feed axis is restricted. In the ninth position adjustment method of the manipulator, the tool rest 2B is arranged such that the touch trigger probe 8 is positioned at the position illustrated in FIG. 24. However, the steps overlapping with the eighth position adjustment method of the manipulator illustrated in FIG. 28 will not be further elaborated here.

After Step S91 and Step S92 are executed, at Step S101, as illustrated in FIG. 24, the tool rest 2B is positioned such that the touch trigger probe 8 is positioned at the touch trigger probe dimension measurement position as the position and posture different from the workpiece grasping preparation position 14 (a fourth sensor positioning step).

At Step S102, the manipulator 10 is moved such that the reference workpiece 13 gripped by the end effector 11 is brought into contact with the touch trigger probe 8 positioned at the touch trigger probe dimension measurement position, and the position and posture of the contact point is obtained similarly to Step S94 (a fourth manipulator position measuring step). S102 as the fourth manipulator position measuring step is repeatedly executed until the measurement termination at the predetermined positions set in advance is confirmed.

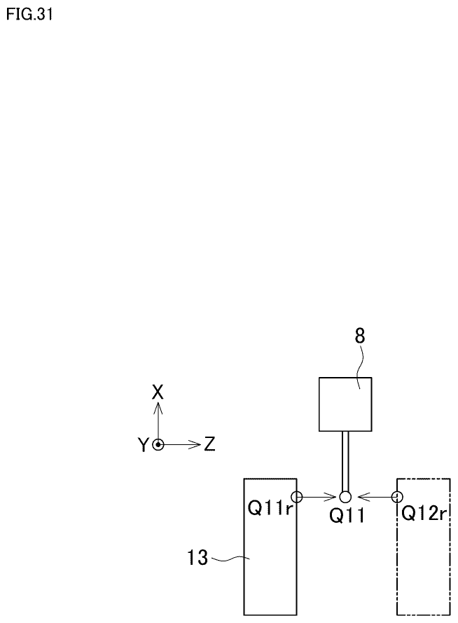

As illustrated in FIG. 31, the touch trigger probe 8 is positioned at a touch trigger probe dimension measurement position Q11 (Xq11, Zq11). Subsequently, the reference workpiece 13 is moved in each of the Z positive direction and the Z negative direction and the touch trigger probe 8 is brought into contact with the side surface of the reference workpiece 13, and a position and posture Q11r (xr11, yr11, zr11, ar11, br11, cr11) of a Z positive direction contact point and a position and posture Q12r (xr12, yr12, zr12, ar12, br12, cr12) of a Z negative direction contact point with respect to Q11 are obtained.

Thereafter, at Step S103, the dimensions of the reference workpiece 13 are calculated from the position and posture of the contact point obtained at Step S102 (a fifth reference object dimension measuring step).

When the reference workpiece 13 has a columnar shape, the diameter D is obtained by the following formula (35). When the reference workpiece 13 has a regular quadrangular prism shape, D in the formula (35) is replaced by the width D′ of the reference workpiece 13. Here, zcn is a compensation value in the Z negative direction, and is, for example, for compensating the error in the Z negative direction of the touch trigger probe 8.

$$D = zr 11 + zcp - zr 12 - zcn + d \qquad ( 35 )$$

Step S93 to Step S97 are repeatedly executed until the threshold determination at Step S96 becomes less than or equal to the threshold, Step S101 to Step S103 may be conveniently included and executed at this time.

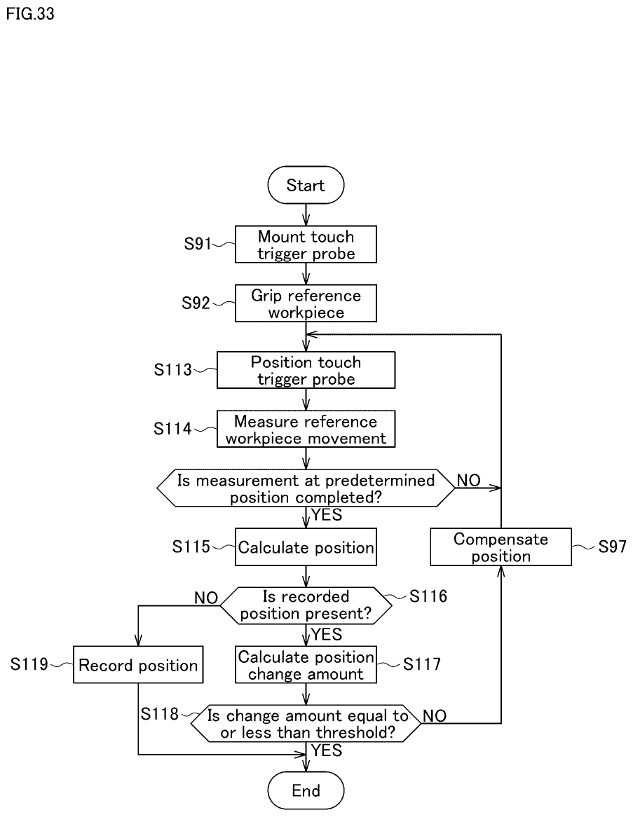

Next, a tenth position adjustment method of the manipulator will be described using the flowchart in FIG. 33. The tenth position adjustment method of the manipulator is executed on the premise that the adjustment of the workpiece grasping preparation position 14 is executed at least once. However, the steps as same as those in the eighth position adjustment method of the manipulator illustrated in FIG. 28 will not be further elaborated here.

Ater Step S91 and Step S92 are executed, at Step S113, similarly to Step S93, the tool rest 2B is positioned such that the touch trigger probe 8 is positioned at the workpiece confirmation position 15 as the proximity of the workpiece grasping preparation position 14 (a fifth sensor positioning step).

At Step S114, similarly to Step S94, the manipulator 10 is moved such that the reference workpiece 13 gripped by the end effector 11 is brought into contact with the touch trigger probe 8 positioned at the workpiece confirmation position 15, and thus, the position and posture of the contact point is obtained (a fifth manipulator position measuring step). Step S114 as the fifth manipulator position measuring step is repeatedly executed until the measurement termination at the predetermined positions set in advance is confirmed.

At Step S115, the position and posture of the reference workpiece 13 is calculated from a plurality of the contact point positions obtained by executing Step S113 and Step S114 for the predetermined positions (a third confirmation position calculating step). Similarly to Step S95, an error value may also be calculated at Step S115.

When the reference workpiece 13 has a columnar shape, the inclination pAw about the X-axis, the inclination pBw about the Y-axis, the X position pXw at the center of the bottom surface, the Y position pYw at the center of the bottom surface, and the Z position pZw on the end surface of the reference workpiece 13 are obtained by the following formula (36) to formula (39).

$$p A w = ( yr 4 - yr 5 ) / ( Zq 5 - Zq 4 ) \qquad ( 36 )$$

$$pBw = ( xr 2 - xr 3 ) / ( Zq 3 - Zq 2 ) \qquad ( 37 )$$

$$pZw = zr 2 + zcp \qquad ( 38 )$$

$$pXw = - ( xr 2 + x c n ) - yr 4 + ycp - yr 6 - ycn + d ) / 2 \qquad ( 39 )$$

$$pYw = - ( yr 6 + ycn + yr 4 + ycp ) / 2 \qquad ( 40 )$$

When the diameter D of the reference workpiece 13 is precisely known, the measurement of the contact point P6 is not necessary, and the X position pXw at the center of the bottom surface is obtained by the following formula (41). The Y position pYw at the center of the bottom surface is obtained by the following formula (42).

$$pXw = - ( xr 2 + x c n ) - D / 2 \qquad ( 41 )$$

$$pYw = - ( yr 4 + ycp ) + D / 2 \qquad ( 42 )$$

When the reference workpiece 13 has a regular quadrangular prism shape, similarly to the case of the columnar shape, the inclination pAw about the X-axis, the inclination pBw about the Y-axis, the X position pXw at the center of the bottom surface, the Y position pYw at the center of the bottom surface, and the Z position pZw on the end surface of the reference workpiece 13 are obtained by the above-described formula (36) to formula (40), respectively. However, the diameter D and the assumed diameter value d in the above-described formula (36) to formula (40) are replaced by the width D′ and the assumed width dimension d′, respectively.

Furthermore, the inclination pCw about the Z-axis is obtained by the following formula (43).

$$p C w = ( yr 7 - yr 4 ) / ( Xq 4 - Xq 7 ) \qquad ( 43 )$$

At Step S116, it is determined whether or not the position and posture of the reference workpiece 13 obtained at Step S115 is recorded. When Step S113 to Step S115 are executed for the first time immediately after the adjustment of the workpiece grasping preparation position 14, the position and posture of the reference workpiece 13 is not recorded. Therefore, at Step S119, the position and posture of the reference workpiece 13 is recorded, and the position adjustment of the manipulator 10 is terminated.

When the position and posture of the reference workpiece 13 is recorded, at Step S117, a difference value between the calculated value of the position and posture of the reference workpiece 13 and the recorded value is calculated as the amount of change in the position and posture of the reference workpiece 13 (a third position change amount calculating step).

At Step S118, it is determined whether or not the amount of change calculated at Step S117 is less than or equal to a predetermined threshold. When the amount of change calculated at Step S117 is equal to or less than the threshold, the position adjustment of the manipulator 10 is terminated as the amount of change is small. The recorded value may be updated using the calculated value of the position and posture of the reference workpiece 13. On the other hand, when the amount of change calculated at Step S117 is larger than the threshold, the position is compensated at Step S97 (a third confirmation position compensating step). In the case, Step S97, Step S113 to Step S117 are repeatedly executed until the amount of change calculated at Step S117 becomes less than or equal to the threshold. The position adjustment of the manipulator 10 may be terminated when the steps are repeated a certain number of times.

While in the above-described embodiments, the description has been made of the compensation of the position of the manipulator 10 by measuring the position and/or the posture of the reference workpiece 13, the workpiece 12 may be used instead of the reference workpiece 13 to execute the disclosure. The threshold of the error of the position and posture of the reference workpiece and the threshold of the amount of change are set in advance from the various information obtained in advance, and are recorded in the numerical control device.

A single numerical control device may control both the machine tool and the manipulator.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A position adjustment method of a manipulator in a machining system, wherein
the machining system includes:
a machine tool including a chuck configured to grasp a workpiece, a tool rest on which a tool is mountable, and three or more translational drive axes that enable a translational motion of the tool rest; and
a manipulator having an end effector configured to grip the workpiece and a plurality of joint driving axes, wherein
the position adjustment method of the manipulator adjusts a position and/or a posture of the end effector at a workpiece grasping position at which the workpiece gripped by the end effector is grasped by the chuck, and
the position adjustment method comprises:
a first reference object positioning step of positioning the manipulator such that a reference object having a specific shape gripped by or secured to the end effector is positioned at a workpiece grasping preparation position near the workpiece grasping position;
a first reference object position measuring step of (i) mounting a contact-type sensor on the tool rest, (ii) moving the tool rest such that the contact-type sensor is brought into contact with the reference object positioned at the first reference object positioning step, (iii) obtaining positions of the translational drive axes when the contact-type sensor detects contacts, and (iv) calculating contact point positions from the obtained translational drive axis positions;
a first reference object position error calculating step of calculating an error of a position and/or a posture of the reference object gripped by or secured to the end effector from a plurality of the contact point positions obtained by executing the first reference object position measuring step for a plurality of positions of the reference object and a command value of the position and posture of the end effector at the first reference object positioning step;
a first manipulator position compensating step of compensating the position and/or the posture of the end effector so as to cancel the error of the position and/or the posture of the reference object calculated at the first reference object position error calculating step.

2. The position adjustment method of the manipulator according to claim 1, further comprising:
a second reference object positioning step of positioning the manipulator such that the reference object gripped by or secured to the end effector has a position and/or a posture different from that at the first reference object positioning step;
a second reference object position measuring step of (i) moving the tool rest such that the contact-type sensor mounted on the tool rest is brought into contact with the reference object gripped by or secured to the end effector positioned at the second reference object positioning step, (ii) obtaining positions of the translational drive axes when the contact-type sensor detects contacts, and (iii) calculating contact point positions from the obtained positions of the translational drive axes; and
a first reference object dimension measuring step of calculating dimensions of the reference object from a plurality of the contact point positions obtained by executing the second reference object position measuring step for a plurality of positions of the reference object, wherein
in the first reference object position error calculating step, the error of the position and/or the posture of the reference object gripped by or secured to the end effector is calculated further using the reference object dimensions calculated at the first reference object dimension measuring step.

3. The position adjustment method of the manipulator according to claim 1, wherein
when the error of the position and/or the posture of the reference object calculated at the first reference object position error calculating step is equal to or more than a predetermined threshold, the first reference object positioning step to the first manipulator position compensating step are repeated.

4. A position adjustment method of a manipulator in a machining system, wherein
the machining system includes:
a machine tool including a chuck configured to grasp a workpiece, a tool rest on which a tool is mountable, and three or more translational drive axes that enable a translational motion of the tool rest; and
a manipulator having an end effector configured to grip the workpiece and a plurality of joint driving axes, wherein
the position adjustment method of the manipulator adjusts a position and/or a posture of the end effector at a workpiece grasping position at which the workpiece gripped by the end effector is grasped by the chuck, and
the position adjustment method comprises:
a first confirmation positioning step of positioning the manipulator such that a reference object having a specific shape gripped by or secured to the end effector is positioned at a preset workpiece confirmation position;
a first confirmation measurement step of (i) mounting a contact-type sensor on the tool rest, (ii) moving the tool rest such that the contact-type sensor is brought into contact with the reference object positioned at the first confirmation positioning step, (iii) obtaining positions of the translational drive axes when the contact-type sensor detects contacts, and (iv) calculating contact point positions from the obtained positions of the translational drive axes;
a first confirmation position calculating step of calculating a position and/or a posture of the reference object gripped by or secured to the end effector from a plurality of the contact point positions obtained by executing the first confirmation measurement step for a plurality of positions of the reference object;
a first position change amount calculating step of calculating an amount of change of the position and/or the posture of the reference object from a calculated value of the position and/or the posture of the reference object calculated at the first confirmation position calculating step and a recorded value of the position and/or the posture of the reference object measured in advance and recorded; and
a first confirmation position compensating step of compensating the position and/or the posture of the end effector so as to cancel the amount of change calculated at the first position change amount calculating step.

5. The position adjustment method of the manipulator according to claim 4, further comprising:
a second confirmation positioning step of positioning the manipulator such that the reference object gripped by or secured to the end effector has a position and/or a posture different from that at the first confirmation positioning step;
a second confirmation position measuring step of (i) moving the tool rest such that the contact-type sensor mounted on the tool rest is brought into contact with the reference object gripped by or secured to the end effector positioned at the second confirmation positioning step, (ii) obtaining positions of the translational drive axes when the contact-type sensor detects contacts, and (iii) calculating contact point positions from the obtained positions of the translational drive axes; and
a second reference object dimension measuring step of calculating dimensions of the reference object from a plurality of the contact point positions obtained by executing the second confirmation position measuring step for a plurality of positions of the reference object, wherein
in the first confirmation position calculating step, the position and/or the posture of the reference object gripped by or secured to the end effector is calculated further using the reference object dimensions measured at the second reference object dimension measuring step.

6. The position adjustment method according to claim 4, wherein
when the amount of change calculated at the first position change amount calculating step is equal to or more than a predetermined threshold, the first confirmation positioning step to the first confirmation position compensating step are repeated.

7. A position adjustment method of a manipulator in a machining system, wherein
the machining system includes:
a machine tool including a chuck configured to grasp a workpiece, a tool rest on which a tool is mountable, and a translational drive axis for enabling the tool rest to perform a translational motion, the tool rest having two or less degree of freedom of the translational motion; and
a manipulator having an end effector configured to grip the workpiece and a plurality of joint driving axes, wherein
the position adjustment method of the manipulator adjusts a position and/or a posture of the end effector at a workpiece grasping position at which the workpiece gripped by the end effector is grasped by the chuck, and
the position adjustment method comprises:
a third reference object positioning step of positioning the manipulator such that the reference object having a specific shape gripped by or secured to the end effector is positioned at a workpiece grasping preparation position near the workpiece grasping position;
a first machine tool position measuring step of (i) moving the tool rest such that a contact-type sensor mounted on the tool rest is brought into contact with the reference object positioned at the third reference object positioning step, (ii) obtaining a position of the translational drive axis when the contact-type sensor detects a contact, and (iii) calculating a machine tool contact point position from the obtained position of the translational drive axis;
a first sensor positioning step of positioning the tool rest such that the contact-type sensor mounted on the tool rest is positioned at the workpiece grasping preparation position;
a first manipulator position measuring step of (i) moving the end effector such that the reference object gripped by or secured to the end effector is brought into contact with the contact-type sensor positioned at the first sensor positioning step, (ii) obtaining positions of the joint driving axes when the contact-type sensor detects contacts, and (iii) calculating manipulator contact point positions from the obtained positions of the joint driving axes;
a second reference object position error calculating step of calculating an error of a position and/or a posture of the reference object gripped by or secured to the end effector at the workpiece grasping preparation position from a command value of the position and posture of the end effector at the third reference object positioning step, a plurality of the machine tool contact point positions obtained by executing the first machine tool position measuring step for a plurality of positions of the reference object, a command value of a plurality of positions of the tool rest when the first sensor positioning step is executed at a plurality of positions of the workpiece grasping preparation position, and a plurality of the manipulator contact point positions obtained by executing the first manipulator position measuring step at the plurality of positions of the workpiece grasping preparation positions; and
a second manipulator position compensating step of compensating the position and/or the posture of the end effector so as to cancel the error of the position and/or the posture of the reference object calculated at the second reference object position error calculating step.

8. The position adjustment method of the manipulator according to claim 7, further comprising:
a fourth reference object positioning step of positioning the manipulator such that the reference object gripped by or secured to the end effector has a position and/or a posture different from that at the third reference object positioning step;
a second machine tool position measuring step of (i) moving the tool rest such that the contact-type sensor mounted on the tool rest is brought into contact with the reference object positioned at the fourth reference object positioning step, (ii) obtaining a position of the translational drive axis when the contact-type sensor detects a contact, and (iii) calculating machine tool contact point positions from the obtained position of the translational drive axis; and
a third reference object dimension measuring step of calculating dimensions of the reference object from a plurality of the machine tool contact point positions obtained by executing the second machine tool position measuring step for a plurality of positions of the reference object, wherein
in the second reference object position error calculating step, the error of the position and/or the posture of the reference object gripped by or secured to the end effector is calculated further using the reference object dimensions obtained at the third reference object dimension measuring step.

9. The position adjustment method of the manipulator according to claim 7, wherein
when the error of the position and/or the posture of the reference object calculated at the second reference object position error calculating step is equal to or more than a predetermined threshold, the third reference object positioning step to the second manipulator position compensating step are repeated.

10. A position adjustment method of a manipulator in a machining system, wherein
the machining system comprising:
a machine tool including a chuck configured to grasp a workpiece, a tool rest on which a tool is mountable, and a translational drive axis for enabling the tool rest to perform a translational motion, the tool rest having two or less degree of freedom of the translational motion; and
a manipulator having an end effector configured to grip the workpiece and a plurality of joint driving axes, wherein
the position adjustment method of the manipulator adjusts a position and/or a posture of the end effector at a workpiece grasping position at which the workpiece gripped by the end effector is grasped by the chuck, and
the position adjustment method comprises:
a third confirmation positioning step of positioning the manipulator such that the reference object having a specific shape gripped by or secured to the end effector is positioned at a workpiece confirmation position different from the workpiece grasping position;
a third machine tool position measuring step of (i) moving the tool rest such that a contact-type sensor mounted on the tool rest is brought into contact with the reference object positioned at the third confirmation positioning step, (ii) obtaining a position of the translational drive axis when the contact-type sensor detects a contact, and (iii) calculating a machine tool contact point position from the obtained position of the translational drive axis;
a second sensor positioning step of positioning the tool rest such that the contact-type sensor mounted on the tool rest is positioned at the workpiece confirmation position;
a second manipulator position measuring step of (i) moving the end effector such that the reference object gripped by or secured to the end effector is brought into contact with the contact-type sensor positioned at the second sensor positioning step, (ii) obtaining positions of the joint driving axes when the contact-type sensor detects contacts, and (iii) calculating manipulator contact point positions from the obtained positions of the joint driving axes;
a second confirmation position calculating step of calculating a position and/or a posture of the reference object gripped by or secured to the end effector at the workpiece confirmation position from a command value of the position and posture of the end effector at the third confirmation positioning step, a plurality of the machine tool contact point positions obtained by executing the third machine tool position measuring step for a plurality of positions of the reference object, a command value of a plurality of positions of the tool rest when the second sensor positioning step is executed at a plurality of positions of the workpiece confirmation position, and a plurality of the manipulator contact point positions obtained by executing the second manipulator position measuring step at a plurality of positions of the workpiece confirmation positions;
a second position change amount calculating step of calculating an amount of change in the position and/or the posture of the reference object from a calculated value of the position and/or the posture of the reference object calculated at the second confirmation position calculating step and a recorded value of the position and/or the posture of the reference object measured in advance and recorded; and
a second confirmation position compensating step of compensating the position and/or the posture of the end effector so as to cancel the amount of change calculated at the second position change amount calculating step.

11. The position adjustment method of the manipulator according to claim 10, wherein
when the amount of change in the position and/or the posture of the reference object calculated at the second position change amount calculating step is equal to or more than a predetermined threshold, the third confirmation positioning step to the second confirmation position compensating step are repeated.

12. A position adjustment method of a manipulator in a machining system, wherein
the machining system includes:
a machine tool including a chuck configured to grasp a workpiece, a tool rest on which a tool is mountable, and a translational drive axis for enabling the tool rest to perform a translational motion; and
a manipulator having an end effector configured to grip the workpiece and a plurality of joint driving axes, wherein
the position adjustment method of the manipulator adjusts a position and/or a posture of the end effector at a workpiece grasping position at which the workpiece gripped by the end effector is grasped by the chuck, and
the position adjustment method comprises:
a third sensor positioning step of positioning the tool rest such that a contact-type sensor mounted on the tool rest is positioned at a workpiece grasping preparation position near the workpiece grasping position;
a third manipulator position measuring step of (i) moving the end effector such that the reference object gripped by or secured to the end effector is brought into contact with the contact-type sensor positioned at the third sensor positioning step, (ii) obtaining a position of the joint driving axis when the contact-type sensor detects a contact, and (iii) calculating a contact point position from the obtained position of the joint driving axis;
a third reference object position error calculating step of calculating an error of a position and/or a posture of the reference object gripped by or secured to the end effector at the workpiece grasping preparation position from command values of a plurality of positions of the tool rest when the third sensor positioning step is executed for a plurality of positions of the workpiece grasping preparation position and a plurality of the contact point positions obtained by executing the third manipulator position measuring step at a plurality of positions of the workpiece grasping preparation position;
a third manipulator position compensating step of compensating the position and/or the posture of the end effector so as to cancel the error of the position and/or the posture of the reference object calculated at the third reference object position error calculating step.

13. The position adjustment method of the manipulator according to claim 12, further comprising:
a fourth sensor positioning step of positioning the tool rest such that the contact-type sensor mounted on the tool rest is positioned at a dimension measurement position different from the workpiece grasping preparation position;
a fourth manipulator position measuring step of (i) moving the end effector such that the reference object gripped by or secured to the end effector is brought into contact with the contact-type sensor positioned at the fourth sensor positioning step, (ii) obtaining a position of the joint driving axis when the contact-type sensor detects a contact, and (iii) calculating a contact point position from the obtained position of the joint driving axis; and
a fifth reference object dimension measuring step of calculating dimensions of the reference object from a plurality of the contact point positions obtained by executing the fourth manipulator position measuring step for a plurality of positions of the reference object, wherein
in the third reference object position error calculating step, the error of the position and/or the posture of the reference object gripped by or secured to the end effector is calculated further using the reference object dimensions obtained at the fifth reference object dimension measuring step.

14. The position adjustment method of the manipulator according to claim 12, wherein
when the error of the position and/or the posture of the reference object calculated at the third reference object position error calculating step is equal to or more than a predetermined threshold, the third sensor positioning step to the third manipulator position compensating step are repeated.

15. The position adjustment method of the manipulator according to claim 12, wherein
the tool rest has two or less degree of freedom of the translational motion.

16. A position adjustment method of a manipulator in a machining system, wherein
the machining system includes:
a machine tool including a chuck configured to grasp a workpiece, a tool rest on which a tool is mountable, and a translational drive axis for enabling the tool rest to perform a translational motion; and
a manipulator having an end effector configured to grip the workpiece and a plurality of joint driving axes, wherein
the position adjustment method of the manipulator adjusts a position and/or a posture of the end effector at a workpiece grasping position at which the workpiece gripped by the end effector is grasped by the chuck, and
the position adjustment method comprises:
a fifth sensor positioning step of positioning the tool rest such that a contact-type sensor mounted on the tool rest is positioned at a workpiece confirmation position different from the workpiece grasping position;
a fifth manipulator position measuring step of (i) moving the end effector such that the reference object gripped by or secured to the end effector is brought into contact with the contact-type sensor positioned at the fifth sensor positioning step, (ii) obtaining a position of the joint driving axis when the contact-type sensor detects a contact, and (iii) calculating a contact point position from the obtained position of the joint driving axis;
a third confirmation position calculating step of calculating a position and/or a posture of the reference object gripped by the end effector from command values of a plurality of positions of the tool rest when the fifth sensor positioning step is executed for a plurality of positions of the workpiece confirmation position and a plurality of the contact point positions obtained by executing the fifth manipulator position measuring step at a plurality of positions of the workpiece confirmation position;
a third position change amount calculating step of calculating an amount of change in the position and/or the posture of the reference object from a calculated value of the position and/or the posture of the reference object calculated at the third confirmation position calculating step and a recorded value of the position and/or the posture of the reference object measured in advance and recorded; and
a third confirmation position compensating step of compensating the position and/or the posture of the end effector so as to cancel the amount of change calculated at the third position change amount calculating step.

17. The position adjustment method of the manipulator according to claim 16, wherein
when the amount of change in the position and/or the posture of the reference object calculated at the third position change amount calculating step is equal to or more than a predetermined threshold, the fifth sensor positioning step to the third confirmation position compensating step are repeated.

18. The position adjustment method of the manipulator according to claim 16, wherein
the tool rest has two or less degree of freedom of the translational motion.
